(19) United States
(12) Patent Application Publication
(10) Pub. No.: US 2024/0383560 A1
(43) Pub. Date: Nov. 21, 2024

(54) A DISTRIBUTED REAL-TIME MACHINE LEARNING ROBOT

(71) Applicant: THE REGENTS OF THE UNIVERSITY OF MICHIGAN, Ann Arbor, MI (US)

(72) Inventor: Weidong XIANG, Ann Arbor, MI (US)

(73) Assignee: THE REGENTS OF THE UNIVERSITY OF MICHIGAN, Ann Arbor, MI (US)

(21) Appl. No.: 18/576,686

(22) PCT Filed: Jul. 5, 2022
(86) PCT No.: PCT/US2022/036114

§ 371 Date: Jan. 4, 2024

Related U.S. Application Data
(60) Provisional application No. 63/218,633, filed on Jul. 6, 2021.

(51) Int. Cl. B62K 11/00; G06V 10/80; G06V 10/84

(52) U.S. Cl. CPC B62K 11/007; G06V 10/80; G06V 10/84

(57) ABSTRACT

An autonomous driving robot based on a two-wheel SEGWAY self-balancing scooter. Sensors including LiDAR, camera, encoder, and IMU were implemented together with digital servos as actuators. The robot was tested simultaneously with the functionality features including obstacle avoidance based on fuzzy logic and 2D grid map, data fusion based on co-calibration, 2D simultaneously localization and mapping (SLAM) and path planning under different scenarios both indoor and outdoor. As a result, the robot initially has the ability of self-exploration with avoiding obstacles and constructing 2D grid map simultaneously. A simulation of the robot with same 10 functionalities except data fusion has also been tested and performed based on robot operating system (ROS) and Gazebo as the simple comparison of the robot in real world.

### CROSS-REFERENCE TO RELATED APPLICATIONS

This application is a 371 U.S. National Phase of International Application No. PCT/US2022/036114 filed on Jul. 5, 2022, which claims the benefit of U.S. Provisional Application No. 63/218,633, filed on Jul. 6, 2021. The entire disclosures of the above applications are incorporated herein by reference.

### FIELD

The present disclosure relates to a distributed real-time machine learning two-wheeled robot.

### BACKGROUND AND SUMMARY

This section provides background information related to the present disclosure which is not necessarily prior art. This section provides a general summary of the disclosure, and is not a comprehensive disclosure of its full scope or all of its features.

In some embodiments, the robot of the present teachings (commonly referred to herein as “xBot”) is a collaborative two-wheeled, self-balancing robot powered with latest real-time deep learning technology. In some embodiments, it is above 1 meter high and able to operate in rooms, fields, factories, indoors and outdoors. In some embodiments, each xBot is equipped with LIDAR, one or more cameras, a GPS sensor, a gyroscope sensor, and several other onboard sensors. In some embodiments, xBots can exchange information among them through available wireless links, including cellular mobile wireless links, local WiFi or LoRa, a low power wide area (LPWA), and/or Bluetooth low energy (BLE) interfaces to remote sensors. Proprietary real-time deep learning on dataset from both lidar point cloud, images and sensors creates advanced functions including intelligence monitoring, modeling, analysis, detection, measurement, and surveillance.

xBot is a leading solution for intelligence surveillance and patrolling for indoors/outdoors facilities, abnormal behavior or intruder detection and monitoring, measuring and positioning of interest targets without presetting, and fast and cost-effective 3D mapping and objective reconstruction. xBot a real-time deep learning (RTDL) robot, built upon a rapid and agile SEGWAY-like scooter featuring with the following aspects.

RTDL: At present, robots respond to environments in designed ways paying little attention to variations and derivations, normally unavoidable and often significant. The story will be changed once real time deep learning (RTDL) is adopted with continuously sensing, instantaneously learning and proactively adjustment to react to variations and uncertainty of environments. As time being, RTDL get more experience, like the Chinese idiom: An older horse knows the way and is able to categorize and model the environments and therefore evolve to fit well the new applications and missions, regularly or unexpectedly.

Multi-Modal Detection: The intelligence based on high-definition images help locate moving or stationary targets while precise distance measurement and positioning are offered by Lidar data, coherently. Moreover, xBot is able to adaptively move around to achieve best performance with an estimate accuracy of centimeter within the ranges up to 100 meters.

Collaborative AI: Moreover, two and more xBots can collaborate or work together with or without cloud to achieve distributed machine learning offering unprecedented functions and performances. Built-in navigation support for waypoint routine as well as intelligence patrolling and cruise.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A illustrates an obstacle avoidance logic.

FIG. 1B illustrates a guiding 2D grid map.

FIG. 2 illustrates a CURM configuration.

FIG. 3 illustrates a FOT configuration of LiDAR.

FIG. 4 illustrates an example flow chart of fusing data from LiDAR and camera.

FIG. 5 illustrates a typical application of data fusion, 3D object co-detection and segmentation, wherein the segmented parts also has semantic information.

FIG. 6 illustrates an example of fuzzy logic based data fusion.

FIG. 7 illustrates a hardware setup and corner extraction for ILCC.

FIGS. 8A-8D illustrate different types of maps, as FIG. 8A is a 3D point cloud map, FIG. 8B is a 2D semantic map, FIG. 8C is a 2D grid map, and FIG. 8D is a 3D semantic map.

FIG. 9 illustrates a general classification of robot path planning.

FIG. 10 illustrates a citation of robotic path planning techniques through years.

FIG. 11 illustrates an example of path planning based on 2D grid map.

FIG. 12A illustrates general classification of machine learning.

FIG. 12B illustrates simple representation of reinforcement learning.

FIG. 13 illustrates a pseudocode of Q-learning.

FIG. 14A illustrates an example of typical maze puzzle problem.

FIG. 14B illustrates a local 2D grid map generated from our robot, which can be as similar as the maze puzzle problem.

FIG. 15 illustrates a hardware setup for the proposed robot.

FIGS. 16A-16B illustrate the kinematic model of the robot, where FIG. 16A illustrates the global and robot coordinates of the robot, and FIG. 16B illustrates the decomposition of the robot's motion.

FIG. 17 illustrates a dynamic model of the robot.

FIG. 18 illustrates a PID controller configuration for the robot.

FIG. 19 illustrates a digital servo structure and PWM working principle.

FIG. 20 illustrates a wiring diagram for servos and Arduino.

FIG. 21 illustrates a vertical scan angle of LiDAR.

FIG. 22 illustrates a visualization of captured point cloud data.

FIG. 23 illustrates a configuration of wheel encoder.

FIG. 24 illustrates a roll, pitch, and yaw of IMU on the robot.

FIG. 25 illustrates a software system framework.

FIG. 26 illustrates a flow chart for obstacle avoidance.

FIG. 27 illustrates a LD, FD, RD on grid map.

FIGS. 28A-28E illustrate fuzzy membership functions of inputs: (a) LD; b) FD; (c) RD; (d) α; (e) v; respectively.

FIGS. 29A-29B illustrate fuzzy membership functions of outputs: (a) θ; (b) α.; respectively.

FIG. 30 illustrates a flowchart for data fusion process.

FIG. 31 illustrates an example scene of collecting data by the robot.

FIG. 32 illustrates a camera, image, and real-world coordinates.

FIG. 33 illustrates a POMDP representation of 2D SLAM.

FIG. 34 illustrates a flowchart of 2D SLAM process.

FIG. 35 illustrates two components of the motion model, wherein within the interval L\hat{ }((i)) the product of both functions is dominated by the observation likelihood in case an accurate sensor is used.

FIG. 36 illustrates a flowchart of path planning process.

FIG. 37 illustrates a save zone (light blue) and dangerous zone (pink) on map for path planning.

FIG. 38A illustrates a model of robot in simulation.

FIG. 38B illustrates a visualization of LiDAR in simulation.

FIG. 39 illustrates an indoor testing environment on simulation. The central dot is the robot model, and the main obstacle includes wall, fire hydrant, and fast-food restaurant.

FIG. 40A illustrates an overview scene of an outdoor testing environment on simulation.

FIG. 40B illustrates a street scene of an outdoor testing environment on simulation.

FIG. 41 illustrates pictures of several test environments, wherein upper left illustrates a university building hallway, middle and lower left illustrate a research lab, and right side illustrate a room.

FIG. 42 illustrates a testing environment for data fusion, where the left illustrates an indoor scenario and the right illustrates an outdoor scenario.

FIG. 43 illustrates a plain view of 2D local grid map and 2D point cloud.

FIG. 44 illustrates a raw image capture from the camera (top) and an undistorted image after calibration (bottom).

FIG. 45 illustrates a mean error in pixels of 25 images (left) and a position of checkerboards in a camera-centric basis (right).

FIG. 46 illustrates a corners of checkers on point cloud.

FIG. 47 illustrates four corners of larger checkerboard with respect to image and point cloud.

FIG. 48 illustrates a colored point cloud of indoor scenario after transformation.

FIG. 49 illustrates a color image, point cloud, and fusion results of indoor and outdoor scenario.

FIG. 50 illustrates a map constructing process with current LiDAR hit (green color) before removing ground hit.

FIG. 51 illustrates a map constructing process without current LiDAR hit after removing ground hit.

FIG. 52 illustrates a result of global 2D grid map in scale of 30×30 m (left) and a corresponding scheme of room (right).

FIG. 53 illustrates a 2D global grid map for path planning in scale of 600×600 pixels (left) and in detail (right).

FIG. 54 illustrates a path generated from different algorithm with the same start and destination.

FIG. 55 illustrates a path planning and navigation of simulation robot, wherein the window tagged “Image” presents the visualization of virtual camera set on the robot model.

FIG. 56 illustrates a 2D grid map generated from Gamapping of simulation.

FIG. 57 illustrates a 3D lase map constructing process of simulation, wherein the left is the 3D lase map and the right is the corresponding real scene in simulation environment.

FIG. 58 illustrates a result of 3D lase map generated by Loam algorithm.

FIG. 59 illustrates a result of 3D lase map generated by Lego-loam algorithm.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### 1.1. Overview

Autonomous driving, as known as self-driving, is a very popular research topic in current which integrates several automated systems including sensing and perception, movement-controlling, networking, artificial intelligent, and decision-making to achieve a safe and fully automated system with little or no human input.

It has been nearly half century for people on the journey of chasing the autonomous driving dream. The word “driving” in autonomous driving reminds that there should be something to be driven. It could be a car, a drone, or a robot. As the most essential transportation in our society, cars were the first to be associated with autonomous driving. The first “autonomous driving car” generally accepted is the Stanford Cart.

What is autonomy? Autonomy is the ability to make your own decisions. In humans, autonomy allows us to do the most meaningful, not to mention meaningless, tasks. This includes things like walking, talking, waving, opening doors, pushing buttons, and changing light bulbs. In robots, autonomy is really no different. Autonomous robots, just like humans, also have the ability to make their own decisions and then perform an action accordingly. A truly autonomous robot is one that can perceive its environment, make decisions based on what it perceives and/or has been programmed to recognize conditions and then actuate a movement or manipulation within that environment. With respect to robot mobility, for example, these decision-based actions include but are not limited to some basic tasks like starting, stopping, and maneuvering around obstacles that are in their way.

Autonomous robots can be useful in many application scenarios. At the current time, autonomous driving is not only concentrated on cars, but it can also be implemented on drones or robots as well. The core concept of typical autonomous driving technology is about sensing from the environment, controlling, and making decisions. This shows a huge similarity with the concept of robots, especially intelligent robots. Therefore, some technologies or algorithms developed from robots can be shared and implemented with vehicles, while developing and testing directly on a robot is more convenient and safer than straightly put a test car on the road. It can be a platform for developing advanced autonomous technologies and algorithms. Also, autonomous driving robots have several unique features and applicable scenarios. Based on the thoughts and relationship of autonomous driving and robots, an autonomous driving robot was built and landed.

### 2.1 Main Objectives

The main objectives of this disclosure include the following five parts as presented:
a). Build an autonomous driving robot based on a SEGWAY self-balancing robot with sensors including a 16-channel solid LiDAR, a RGB camera, wheel encoders, a gyroscope, and actuator including servos and microcontrollers.
b). Based on this robot, realize several basic functions including movement control, sensing, and wheel odometer.
c). Based on these basic functions, develop and realize several autonomous driving functions including obstacles avoidance, 2D simultaneously localization and mapping (2D SLAM), camera & LiDAR data fusion and path planning.
d). Test the performance of the robot and integrate all the autonomous driving functions mentioned to the robot simultaneously without decrease the response speed.
e). Establish a simulation environment and model based on ROS and Gazebo with all of the autonomous driving functions mentioned in 1.2.c and implement some other algorithms to the simulation to validate and explore the potential and capability of some possible future research work underneath this robot.

Besides, the following several technologies and algorithms will be discussed and presented in this disclosure including:
a). Two-wheel differential kinematics model.
b). Microcontroller and servo.
c). Obstacle Avoidance.
d). LiDAR and point cloud.
e). Sensor data fusion.
f). SLAM and filtering.
g). Path planning.

Some other technologies and principles used in the simulation part will not be within the scope of our discussion.

### 2.2 Obstacle Avoidance

Obstacle avoidance is one of the most essential functions for an autonomous driving robot for the reason of keeping the robot safe at all times. The two main concerns when implementing obstacle avoidance to a robot include the choice of sensor and algorithm. There are several types of sensor choices for different applicational scenarios as shown in Table 1, while the algorithm chosen might not vary significantly because the principle shows the same.

TABLE 1
Advantages and limitation of various sensors within USVS.

| Sensors | Advantages | Limitations |
|---|---|---|
| Millimeter-Wave | Long detecting range. | Limited small and dynamic |
| Radar | Good velocity | target detection capability. |
| | estimates. | Motion distortion; |
| | All-weather and broad- | |
| | area imagery. | |
| LiDAR | High depth resolution | Angular resolution both |
| | and accuracy. | vertically and horizontally. |
| | Suitable for both | Sensitive to motion. |
| | indoor and outdoor | High cost. |
| | scenario. | |
| | Wide scan range. | |
| Visual Sensor | High lateral and | Low depth resolution and |
| | temporal resolution. | accuracy. |
| | Simplicity and low | Challenge to real-time |
| | weight. | implementation. |
| | | Sensitive to light and |
| | | weather. |
| Infrared Sensor | Applicable for dark | Indoor use only. |
| | conditions. | Impressionable to |
| | Low power | interference and distance. |
| | consumption. | |

Algorithms for obstacle avoidance can be divided into two types. The traditional algorithms including Artificial Potential Field (APF) and Virtual Force Field (VFF) usually have satisfactory real-time performance and high safety margin, but it cannot achieve good results in a dynamic environment. The opposite one is intelligent optimization algorithms including Fuzzy Logic Algorithm (FLA), Genetic Algorithm, Rapidly Random-exploring Trees (RRT) and so on. The most notable advantage for intelligent optimization algorithms is good performance in dynamic environment. The response is rapid for moving obstacles, which can improve the safety. The completeness of these algorithms is to deal with the complex conditions of real roads and possible potential unknown threats.

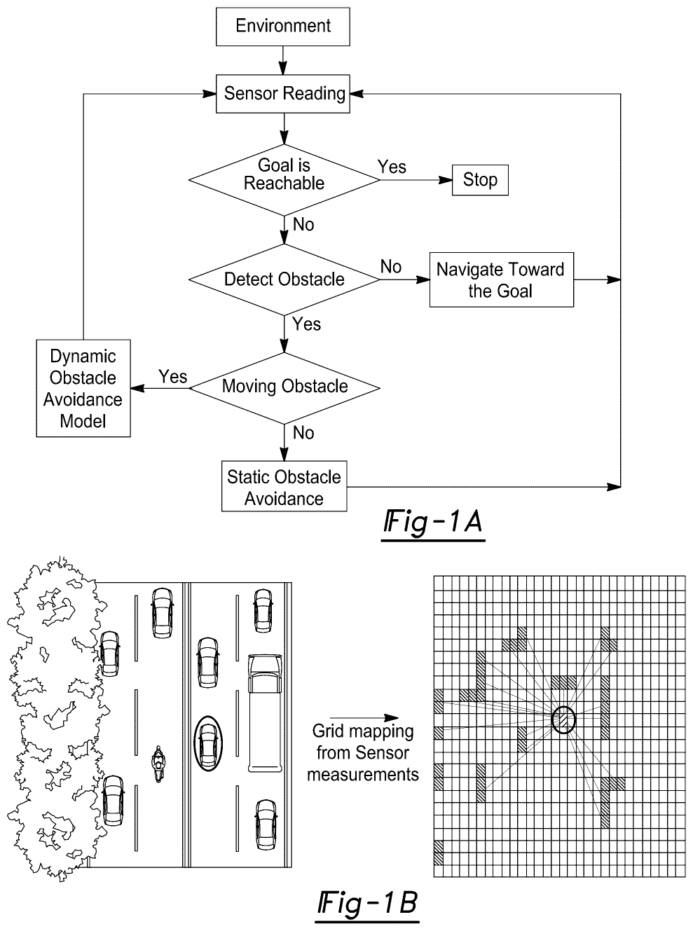

There is a famous theory in artificial intelligent goes as “There's no free lunch”. For different practical applicational scenarios, the choice of sensors and algorithms should be flexible to balance the cost and performance. A simple logic for obstacle avoidance can be described as shown in FIG. 1A. This kind of logic is always implemented with grid mapping as shown in FIG. 1B. The information provided by grid map has lower resolution which is suitable for simple logic.

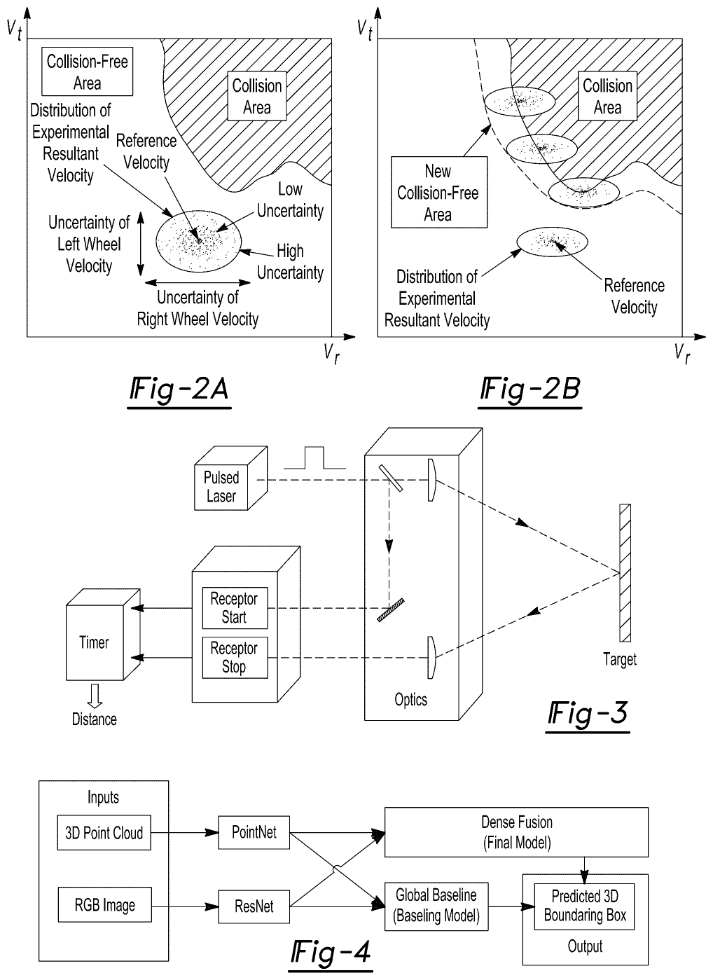

There is another logic for obstacle avoidance that published recently called the clearance considering the uncertainly of the robot motion (CURM) as shown in FIG. 2. This algorithm is a kind of local obstacle avoidance that designed based on velocity control, where CURM is the smallest value in the uncertainty ellipse of the reference velocity. Our method shows similarity with both the CURM and the simple logic in FIG. 1, and it will be presented later in Section 3. This kind of logic shows high performance in dynamic environment, where the global map is uncertain, and obstacles are moving.

Obstacle avoidance technology is always implemented with the company of path planning (routing), as part of the decision-making processes.

### 2.3 LiDAR and Point Cloud

As one of the most crucial sensors in autonomous driving technologies, lase radar, or LiDAR has the ability of sensing the environment comprehensively in stereo. It also has an extensive application in researching and industry. LiDAR can be divided to several different types including 2D/3D, single/multi-channel, 360/180 and so on, while in this disclosure we focus the application of 3D multi-channel LiDAR mainly on autonomous driving.

LIDAR can be useful in almost every function of autonomous driving. A typical LiDAR for autonomous driving is usually a solid multi-channel one, which uses time-of-flight (TOF) when measuring, as shown in FIG. 3. The received optic pules will be decoded as plenty of points containing both position and reflection intensity information, which are called point cloud. A typical point cloud data after decoding is formatted as [x y z intensity].

In this disclosure, a 16-channel solid LiDAR will be implemented to our robot for supplying point cloud data of realize Occupied Grid Obstacle Avoidance, Camera & LIDAR Data Fusion and 2D SLAM.

### 2.4 Sensor Data Fusion

Sensor data fusion is a powerful technology which can combine different type of sensors together, lead them to take advantages and complement disadvantages together. The application of sensor data fusion in autonomous driving can be simple such as object co-detection, or more complicated such as 3D reconstruction, and semantic map construction, as shown in FIG. 5.

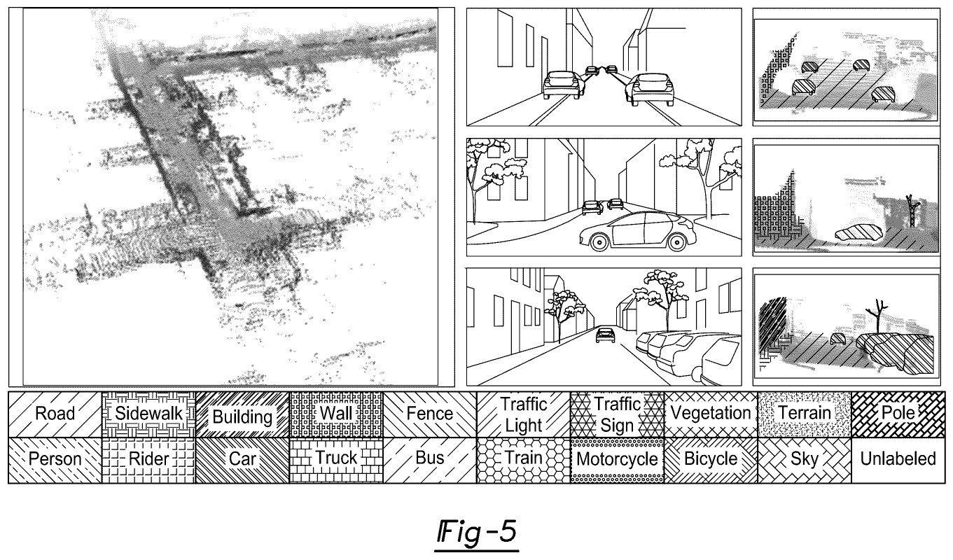

One example of fusing LiDAR and camera together is to use machine learning, such as the flowchart shown in FIG. 4. However, for precise calibration, the precondition of fusing sensors is to know the spatial relative relationship, which means the sensors should be calibrated in advance to generate the intrinsic and extrinsic matrices of both camera and LiDAR. For some open-source dataset such as KITTI, the intrinsic and extrinsic matrices have already been calibrated, but since this robot was built on our own, the camera and LiDAR needed to be calibrated from scratch.

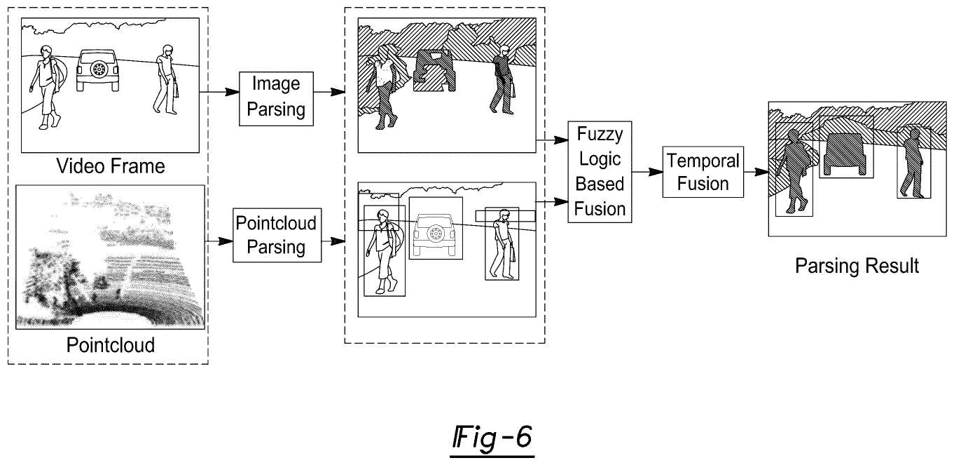

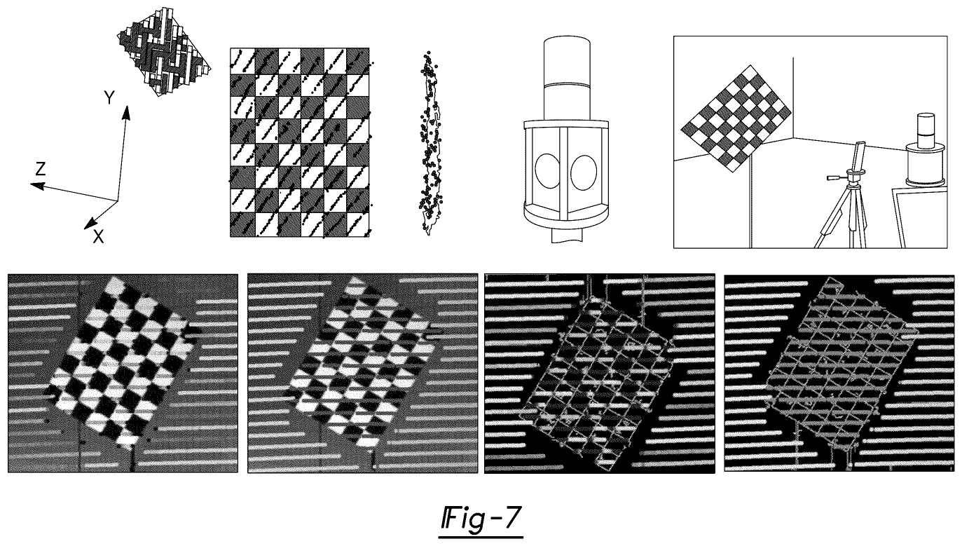

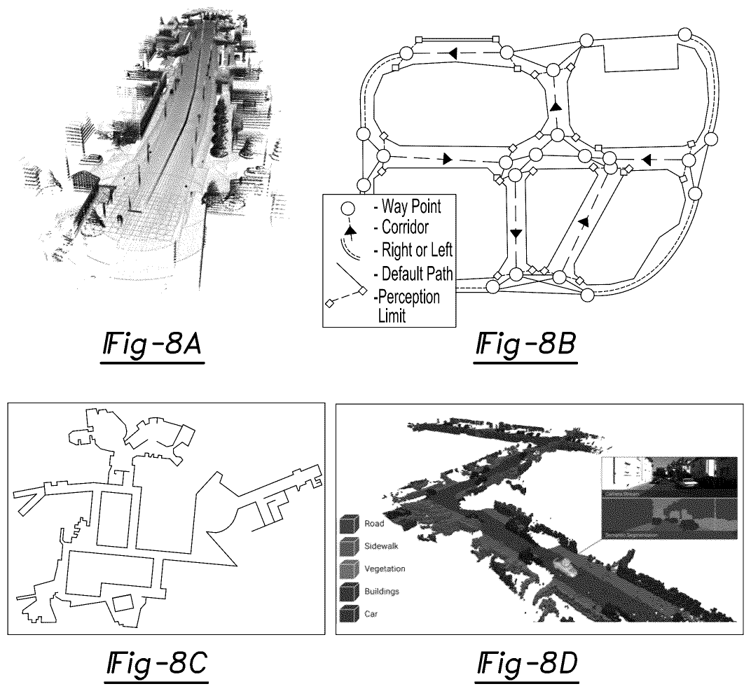

The key to calibration is to extract the identical features from both image and point cloud then match them together. There are several existing methods for calibration as shown in FIG. 6 uses fuzzy logic to fuse the parsed image and point cloud together, no matter what kind of object is providing the features. Another method is more suitable and robust for fixed position sensors. The key about this method is to use a checkerboard as the landmark. First it detects and estimate the corner of each checkers both in image and point cloud, then with the intrinsic matrix calibrated from camera alone, it can re-project each corner from point cloud back to image in a same coordinate and calculate the reprojection error. Some improvements can be implemented with the application of refinement and optimization algorithms. For example, in ILCC, an optimization cost function based on the constraints of the correspondence between the intensity and color was formulated, as shown in FIG. 7. Our method of calibration and fusing data from LiDAR and camera is based on ILCC, which will be presented in Section 3 particularly.

### 2.5 SLAM and Filtering

Localization and mapping are one of the major focuses of autonomous driving and robotics because it is usually the prerequisite of path planning. SLAM comprises the simultaneous estimation of the state of a robot equipped with sensors, and the construction of a model (map) of the environment that the sensors are perceiving. The need to use a map of the environment is twofold. First, the map is often required to support other tasks; for instance, a map can inform path planning or provide an intuitive visualization for a human operator. Second, the map allows limiting the error committed in estimating the state of the robot. In the absence of a map, dead reckoning would quickly drift over time; on the other hand, using a map, e.g., a set of distinguishable landmarks, the robot can “reset” its localization error by re-visiting known areas (so-called loop closure). Therefore, SLAM finds applications in all scenarios in which a prior map is not available and needs to be built. In autonomous driving and robotics map can be divided into several types depends on the usage and information contained as shown in FISG. 8A-8D. However, in this disclosure we focus only on grid map since the primary application of the map is for path planning.

SLAM also can be divided into several types. People usually divided SLAM into two manifolds by the usage of sensor including vision SLAM and lase SLAM. Both these two approaches of SLAM have their advantages and disadvantages, as shown in Table 2.

TABLE 2
Comparison between lase & vision SLAM in some aspects.

| | Lase SLAM | Vision SLAM |
|---|---|---|
| Cost | High | Much lower |
| Application | More indoor, but can do | Both indoor and outdoor, |
| Scenario | outdoor | high optic dependence |
| Accuracy of Map | High, can be used for | Lower |
| | navigation or path | |
| | planning directly | |
| Usability | Collect point cloud with | Indirectly, more steps for |
| | depth information | collecting depth |
| | directly | information |
| Hardware Setup | Relatively larger and | Light and portable |
| | heavier | |

Compared with vision SLAM, lase SLAM is much suitable for the application of the robot presented in this disclosure. lase SLAM can be divided into two types including Filter-based and Graph-based depends on the algorithm implemented. Filter-based SLAM modeled the localization and mapping process as a probabilistic problem, which use a probabilistic filter to estimate the robot's pose simultaneously in each frame with the input of lase scan and odometer. Graph-based SLAM create sub-graphs to represent the state and map of the robot and use nonlinear least squares to optimize those graphs. Table 3 presents the development and features of lase SLAM.

The quality of map can be critical for affecting the performance of the robot. A poorly constructed map with low accuracy may provide fallacious coordinates for robots and may lead to a crash. Plus, the robot must know the current location of itself, which is a prerequisite of the overall mapping process. Based on the consideration of our robot's practical application and software development environment, the Optimal RBPF 2D SLAM is the most suitable algorithm, which is lighter than graph-based methods with high accuracy compared to other filter-based methods.

The abbreviation RBPF represents Rao-Blackwellized Particle Filter. As an extension of particle filter, RBPF is a powerful tool for solving state estimation problems. As mentioned before, filter-based SLAM modeled the localization and mapping process as a probabilistic problem, which can be formulated as a posterior distribution over the state variables consisting of the robot map m={mᵢ} and robot trajectory x_{1:t}={x₁, . . . , xₜ} conditioned on the sequence

TABLE 3
Configuration of lase SLAM through development.

| Year | SLAM | Sensor | Feature |
|---|---|---|---|
| 1988 | EKF-SLAM | 2D LiDAR | Only feature map built, large |
| | | | computational complexity and |
| | | | poor robustness |
| 2002 | FastSLAM | 2D LiDAR | First algorithms for building grid |
| | | | map; |
| | | | High memory consumption and |
| | | | particle dissipation |
| 2007 | Gmapping | 2D LiDAR | Less particle dissipation, high |
| | | | odometer dependency |
| 2010 | Optimal | 2D LiDAR | Best performance for filter-based |
| | RBPF | | SLAM, relative light-weighted |
| 2010 | Karto SLAM | 2D LiDAR | First graph-based SLAM |
| | | | algorithm, high time consumption |
| | | | and non-real time |
| 2011 | Hector- | 2D LiDAR | No odometer needed; |
| | SLAM | | Sensitive to initial value, map will |
| | | | drift when robot rotated |
| 2014 | LOAM | 3D LiDAR | First 3D lase SLAM algorithm; |
| | | | Assume the robot moves in |
| | | | constant speed; |
| | | | No loop-closure |
| 2015 | V-LOAM | 3D LiDAR | High accuracy and robustness; |
| | | & Vision | Fuse lase and vision sensor |
| | | | together; |
| 2016 | Cartographer | 2D LiDAR | Graph-based 2D SLAM; |
| | | | Similar performance with Optimal |
| | | | RBPF |
| 2016 | VELO | 3D LiDAR | With loop-closure; |
| | | & Vision | Less map drifting |
| 2018 | IMLS | 3D LiDAR | Pure lase input, no rely on GPS, |
| | | | IMU, vision sensors with less |
| | | | map drifting |

of sensor observations z_{1:t}={z₁, . . . , zₜ} and control commands u_{1:t}={u₁, . . . , uₜ}. It uses several numbers of particles to represent the posterior and after each interval it will update these particles and resample them to acquire the right location of robot and forward to the next interval. Based on this assumption, RBPF SLAM split localization and mapping apart, construct the map after the robot's current pose was determined. The relatively simple process of particle filter causes it lighter than graph-based methods while the resampling step also cause a common failing called particle degeneracy. Particle degeneracy means after several iterations of resampling, some particles carrying correct information might be dumped and the diversity of particles might downgrade. In terms of this problem, RBPF applied two improvements. The first one is called selective resampling, which set a threshold at the resampling step. This will only resample those particles with large weights whose distance between current distribution center is smaller. The second one is to use distribution of improvement proposal, which means it will consider the result of the most recently sensor reading when give a weighting to particles, since the observation of sensors are always more accurate than control commands. With these two improvements, RBPF has fewer times of resampling and numbers of particles to prevent the particle degeneracy problem, while it also gained higher accuracy.

The research about RBPF SLAM (or more widely the filter-based SLAM) is still ongoing. Many researchers presented vary kinds of methods to improve the performance, e.g. But those works will not be discussed too much since the theoretical background of our works is already enough. Next in Section 3, our method will be presented in detail about how we implement RBPF to our robot, what kind of adjustments we have made and the way we make it real-time.

### 2.6 Path Planning and Reinforcement Learning

In this part, the background of robot path planning will be mainly introduced since the topic of disclosure is autonomous driving robot. Besides, the primary purpose of this disclosure is to build an autonomous driving robot which can be also used as an algorithm development platform. Hence, some of the advanced technologies related to path planning will also be introduced. In here we will mainly focus on the most popular research direction, reinforcement learning.

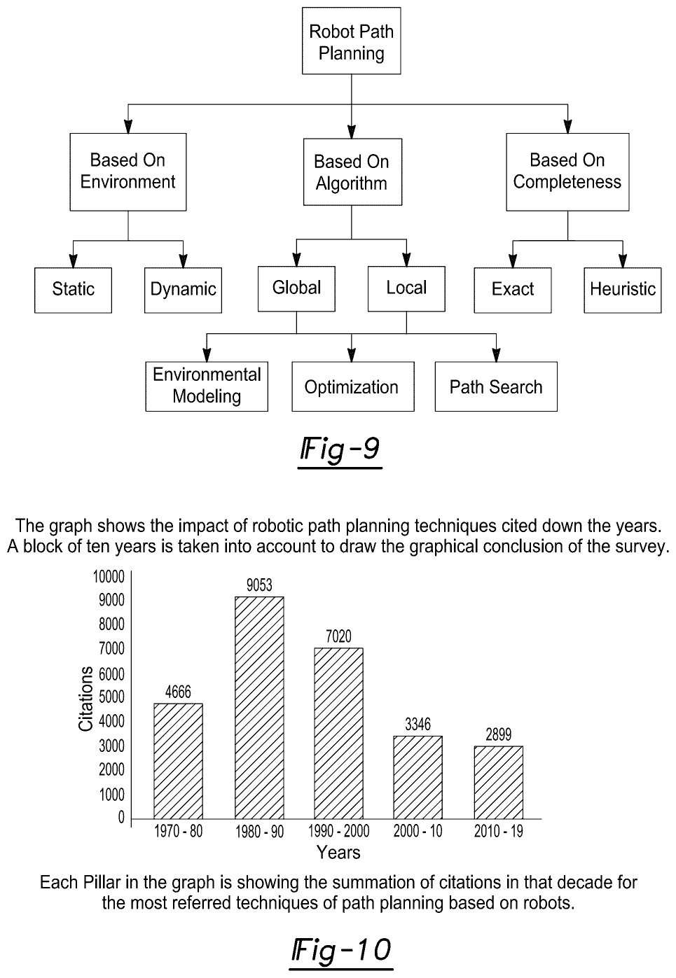

Path planning, or as known as routing, navigation technologies are well known while playing an essential role in autonomous driving and robotics. Generally, people describe the path planning problem as a process or activity to plan and direct a route or path from a position to a goal on the map. In fact, the three general problems of path planning include localization, mapping, and motion control, which has been introduced before and will be discussed in detail as the main focus of this disclosure. Path planning research of autonomous driving and robotics has attracted attention since the 1970s. Over the past several years and recently, research in this area has increased due to the reason that autonomous robots are now applied in various applications. Thus, through many years of development and evolution, the classification of path planning has been divided into many domains, as shown in FIG. 9. In here, we focus only on 2D environment since the robot presented in this disclosure can be classified as a ground autonomous mobile robot. Under the 2D environment domain, the path planning technologies can also be divided into several domains according to the emphasis, as shown in FIG. 9.

FIG. 10 presents a survey about the impact of robotic path planning algorithms cited down the years. Obviously, the heyday of the path planning algorithm development began from 1980s and tend to stable gradually after 2000s. One of the major possible reasons is the fever of nature-inspired algorithms. The nature-inspired algorithms for path planning have a wide application including Artificial Neural Networks, Ant Colony Optimization, Bee Colony, Firefly Algorithm, Particle Swarm Optimization, Bacteria Foraging, BAT Algorithm and so on. However, the cited papers tend to include more on doing advancements on some prominent algorithms such as A star (A*) algorithm, Rapidly Exploring Random Tree and so on. Also, the rapid development of artificial intelligence also has an impact of path planning technologies, which is embodied as the implementation of Reinforcement Learning (RL).

Hence, in this chapter, some related works about path planning and reinforcement learning under in the context of this disclosure will be introduced including A star (A*) algorithm, Dijsktra algorithm, A star Heuristic algorithm, Greedy algorithm, and reinforcement learning.

For A stat (A*) and A* Heuristic: A* is actually a kind of search algorithm, especially in graph traversal and path search. It can be implemented on path planning when using a grid map to represent the environment. More specifically, A* is an informed search algorithm, or better known as best-first search, meaning that it is formulated in terms of weighted graphs. Starting from a specific starting node of a graph, it aims to find a path to the given destination node with the smallest cost (shortest path or time, etc.). This is realized by maintaining a tree of paths originating at the start node and extending those paths one edge at a time until its termination criterion is satisfied.

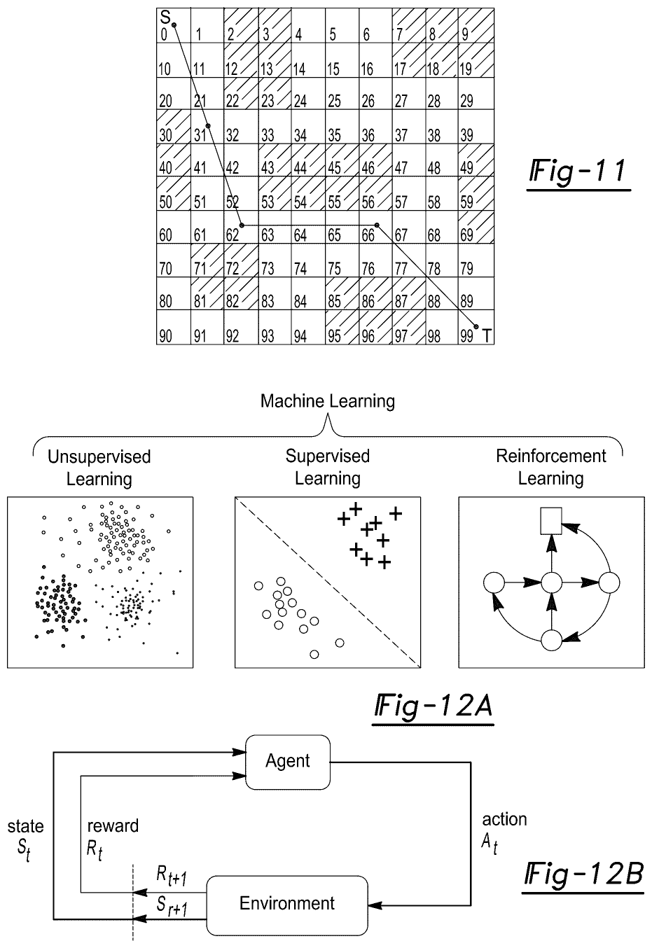

At each iteration of its main loop, A* needs to determine which of its paths to extend based on the cost of the path and an estimate of the cost required to extend the path to the destination. This can be formulated as a minimization:

$$f ( n ) = g ( n ) + h ( n )$$

Where n is the next node on the path, g(n) is the cost of the path from start node to n, and h(n) is a heuristic function that estimates the cost of the cheapest path from n to destination. A* terminates when the path it chooses to extend is a path from start to destination or if there are no paths eligible to be extended. In here, since we are using grid map instead of graph, an example of implementing A* can be described as shown in FIG. 11.

For Dijsktra: Similar with A*, Dijsktra is a kind of search algorithms by minimizing the cost from start to destination. The method of describing the environment used by Dijsktra is the same as A* that, it uses nodes to define each position the robot can reach. However, the difference is, Dijkstra uses labels that are positive integers or real numbers, which are totally ordered. It can be generalized to use any label that are partially ordered, provider the subsequent labels (a subsequent label is produced when traversing an edge) are monotonically non-decreasing.

The original algorithm uses a min-priority queue. Let the node at which we are starting to be called the initial node, and the distance of node Y be the distance from the initial node to Y. Then the process of Dijkstra algorithm can be described as assigning some initial distance values and trying to improve them step by step:
Mark all nodes unvisited. Create a set of all the unvisited nodes called the unvisited set.
Assign to every node a tentative distance value: set it to zero for our initial node and to infinity for all other nodes. Set the initial node as current.

For the current node, consider all of its unvisited neighbors and calculate their tentative distances through the current node. Compare the newly calculated tentative distance to the current assigned value and assign the smaller one. For example, if the current node A is marked with a distance of 6, and the edge connecting it with a neighbor B has length 2, then the distance to B through A will be 6+2=8. If B was previously marked with a distance greater than 8 then change it to 8. Otherwise, the current value will be kept.

When we are done considering all of the unvisited neighbors of the current node, mark the current node as visited and remove it from the unvisited set. A visited node will never be checked again.

If the destination node has been marked visited (when planning a route between two specific nodes) or if the smallest tentative distance among the nodes in the unvisited set is infinity (when planning a complete traversal; occurs when there is no connection between the initial node and remaining unvisited nodes), then stop. The algorithm has finished.

Otherwise, select the unvisited node that is marked with the smallest tentative distance, set it as the new “current node”, and go back to step 3.

For Greedy algorithm: Greedy algorithm, or as known as greedy strategy is actually a kind of method about solving problems, which is mostly applied in optimization problems. The algorithm makes the optimal choice at each step as it attempts to find the overall optimal way to solve the entire problem. The greedy algorithm can be implemented to solve the problem if both properties below are satisfied:

Greedy choice property: A global optimal solution can be reached by choosing the optimal choice at each step.

Optimal substructure: A problem has an optimal sub structure if an optimal solution to the entire problem contains the optimal solutions to the sub-problems.

For path planning problem, greedy algorithm can be applied to Dijkstra algorithm since Dijkstra algorithm satisfied the two properties.

For Reinforcement Learning: The reinforcement learning is a unique classification of machine learning alongside from supervised and unsupervised learning, as shown in FIGS. 12A-12B. The entire area about reinforcement learning has already developed into a vast field and implemented to various theoretical or practical application scenarios. So, in here, we will only introduce the part of the reinforcement learning area which will be used for path planning of our robot. The primary process of reinforcement learning can be described as an interaction between an intelligent agent and the environment. The intelligent agent will take actions in an environment in order to maximize the notion of cumulative reward. Reinforcement learning can also be divided into many different classifications. We will not list and introduce all of these categories but focusing on Q-learning, a model-free reinforcement learning algorithm.

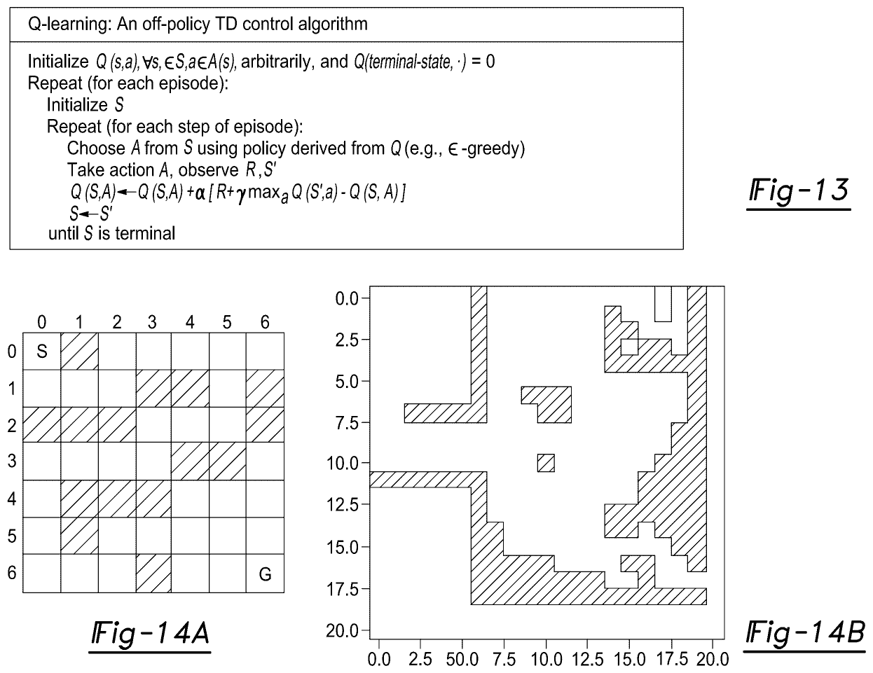

Q-learning algorithm can be described as shown in the pseudocode in FIG. 13. Before learning begins, Q is initialized to a possibly arbitrary fixed value (chosen by the programmer). Then, at each episode or time t the agent selects an action a, observes a reward R, enters a new state and Q is updated. The core of the algorithm is a Bellman equation is about updating the simple iteration value Q(S, A) using the weighted average of the old value and the new information:
R is the reward received when moving from state S to S′.
Q(S, A)−αQ(S, A) is the current value weighted by the learning rate. Values of the learning rate near to 1 made faster the changes in Q.
αR is the reward R=R(S, A) to obtain if action A is taken when in state S.
αy·maxₐQ(S′, a) is the maximum reward that can be obtained from state S′.

An episode of the algorithm ends when state S is a final or terminal state.

The reason for choosing Q-learning is that one of the most classic practical application of Q-learning is the maze puzzle problem, which is similar to path planning on a 2D grid map of this disclosure. A typical maze puzzle problem can be described in FIG. 14.

The process of solving this maze problem by using Q-learning is to train an agent to find the optimal path starting from grid (0,0) to (6,6), given no prior knowledge of the environment. To encourage the robot to find the shortest path, a small penalty of 0.04 units is applied each time the robot moves into an empty (white) cell, and obstacles are places around the maze (marked in gray) which result in a larger penalty of 0.75 units if the robot enters a cell containing one of them. The robot can only move up, down, left or right (that is, diagonal moves are not allowed). However, a level of uncertainty is associate with each movement, such that there is only an 80% chance the robot will move in the intended direction and a 20% chance the robot moves at right angles to the intended direction (split evenly between the two possibilities). The robot is unable to move outside the boundaries of the maze, and if it attempts to do so, bumps into the wall and its position remains unchanged. If the robot successfully makes it to the end of the maze, it receives a reward of 1 unit. Assuming a discount rate of 0.9, a learning rate of 0.3 and an epsilon greedy exploration strategy with (constant) epsilon equal to 0.5, after 50,000 iterations of the Q-learning algorithm we get the following policy. The diagram shows the optimal direction for the robot to take in each square of the grid.

Thus, the key of solving the problem through Q-learning is to keep updating the value on Q-table and making decisions on some states for next movement according to the new value.

### Section 3 Approach

### 3.1 Hardware Schematic of the Robot

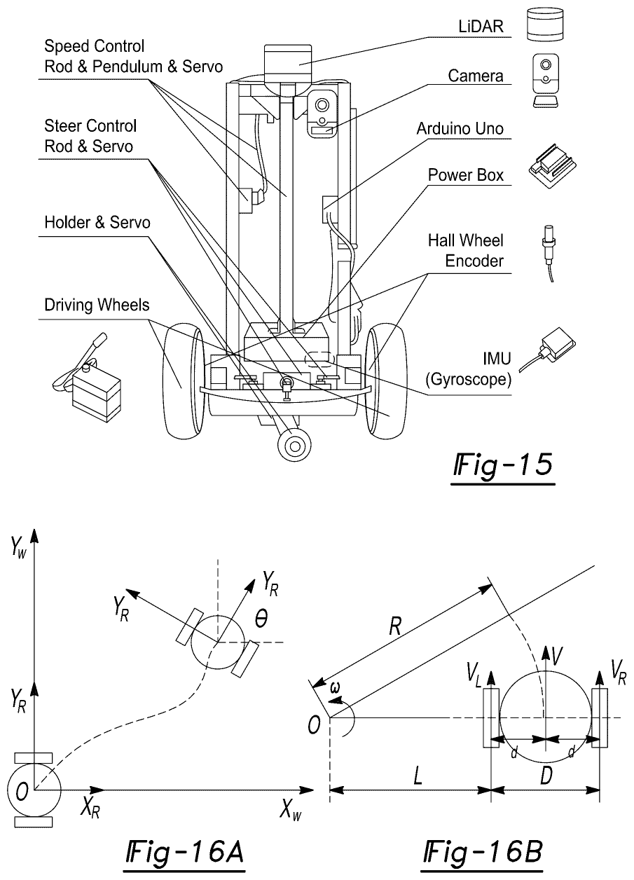

The hardware setup and selection can be described in FIG. 15 and Table 4. A SEGWAY Ninebot S two-wheel self-balancing scooter was selected as the basic and we modified it except its own driving system. Instead, we installed a slope-driven pendulum mechanism to control the speed and a cross rod to control the steering. Once the robot was powered on, it can keep balancing by itself and we achieve control over the robot through two servos connected to the pendulum and cross rod. At the bottom of the robot there is another servo connected to a holder to keep it standing while power off. More detailed information about how we control the robot will be presented in Section 3.3.1 after the kinematic and dynamic model was introduced in Section 3.2.

TABLE 4
Hardware configuration of the presented robot.

| Sensor | Actuator | Other Hardware |
|---|---|---|
| LS 16 Channel LiDAR | DS3225 25 kg | Arduino Uno × 2 |
| HIKVISION | Digital Servo × 3 | Microsoft Surface |
| DS-2CD2455FWD-IW | | |
| Network Camera | | |
| WitMotion WT901C-485 | | Magnets × n |
| 9 Axis IMU (Gyroscope) | | |
| S&C 103SR13A-1 Hall Effect | | 6105-T5 Aluminum |
| Magnetic Sensor × 2 | | T-Slotted Extrusion |

The selection of sensors has also been shown in Table 3.1. A LS 16 Channel LiDAR and a HIKVISION DS-2CD2455FWD-IW network camera were selected as the main environment perception system, while a WitMotion WT901C-485 9 Axis IMU (Gyroscope) and two S&C 103SR13A-1 Hall Effect Magnetic Sensors formed the self-state perception system. For integrating those sensors and actuators together, a Microsoft Surface laptop and two Arduino Uno microcontrollers were selected. More detailed information about data format and acquisition will be introduced in Section 3.3.2.

### 3.2 Kinematic and Dynamic Model of the Robot

### 3.2.1 Two-Wheel Differential Kinematic Model

The chassis kinematic model of the Robot can be represented as a two-wheel differential model, from where we can calculate the expected kinesiology including pose (X,Y coordinate relative to global and azimuth) angular and linear velocity and so on from the input of sensors as illustrated in FIGS. 16A-16B.

As shown in FIG. 16B, the motion of the robot can be decomposed as a kind of circular motion. V and ω represent the linear and angular velocity of the whole robot, while V_{L} and V_{R} are the linear velocity of the robot's left and right wheel. d is half of the spacing between left and right wheel. If we set V and ω to known, then the velocity of left and right wheel can be determined as:

$${V}_{L} = ω \times ( L + D ) = ω \times ( L + 2 d ) = ω \times ( R + d ) = V + ω d \qquad ( 3.1 )$$

$${V}_{R} = ω \times L = ω \times ( R - d ) = V - ω d \qquad ( 3.2 )$$

On the contrary, V and ω can be determined from wheel speed too:

$$V = ω \times R = ω \times ( L + d ) = \frac{2 ω L + 2 ω d}{2} = \frac{ω L + ω ( L + 2 d )}{2} = \frac{{V}_{L} + {V}_{R}}{2} \qquad ( 3.3 )$$

$$ω = \frac{{V}_{L} - {V}_{R}}{2 d} \qquad ( 3.4 )$$

Or we can use vectors to represent as:

$$( \begin{matrix}V \\ ω\end{matrix} ) = [ \begin{matrix}\frac{{r}_{L}}{2} & \frac{{r}_{R}}{2} \\ - \frac{{r}_{L}}{2 d} & \frac{{r}_{R}}{2 d}\end{matrix} ] ( \begin{matrix}{ω}_{L} \\ {ω}_{R}\end{matrix} ) \qquad ( 3.5 )$$

In (a) we use odometery model to calculate the position of the robot. Odometery model can integrate the position and azimuth of the robot relative to the global coordinate at any time. 0 is the angle between any current X_{R} and X_{w}. There're actually two methods to calculate the position, the first one is to use wheel speed and integration, which has higher error:

$${X}_{t} = {X}_{t - 1} + Δ {x}_{w} = {X}_{t - 1} + Δ d * cos ( θ ) = {X}_{t - 1} + Δ t * V * cos ( θ ) \qquad ( 3.6 )$$

$${Y}_{t} = {Y}_{t - 1} + Δ {y}_{w} = {Y}_{t - 1} + Δ d * sin ( θ ) = {Y}_{t - 1} + Δt * V * cos ( θ ) \qquad ( 3.7 )$$

Or it can be determined directly from the increments of the wheel encoder:

$${X}_{t} = {X}_{t - 1} + Δ {x}_{w} = {X}_{t - 1} + Δ e * \frac{2 π r}{s} * cos ( θ ) \qquad ( 3.8 )$$

$${Y}_{t} = {Y}_{t - 1} + Δ {y}_{w} = {Y}_{t - 1} + Δ e * \frac{2 π r}{s} * sin ( θ ) \qquad ( 3.9 )$$

Δe is the increment of wheel encoder pluses in a unit time Δt (Δt usually will be set as 10 or 20 ms), S is the total number of pulses of the encoder when the wheel moves one revolution, and r is the radius of the wheel. θ can be read directly from the gyroscope's yaw. In that case, from the odometery model we can determine the pose and trajectory of the robot.

### 3.2.2 Dynamic Model

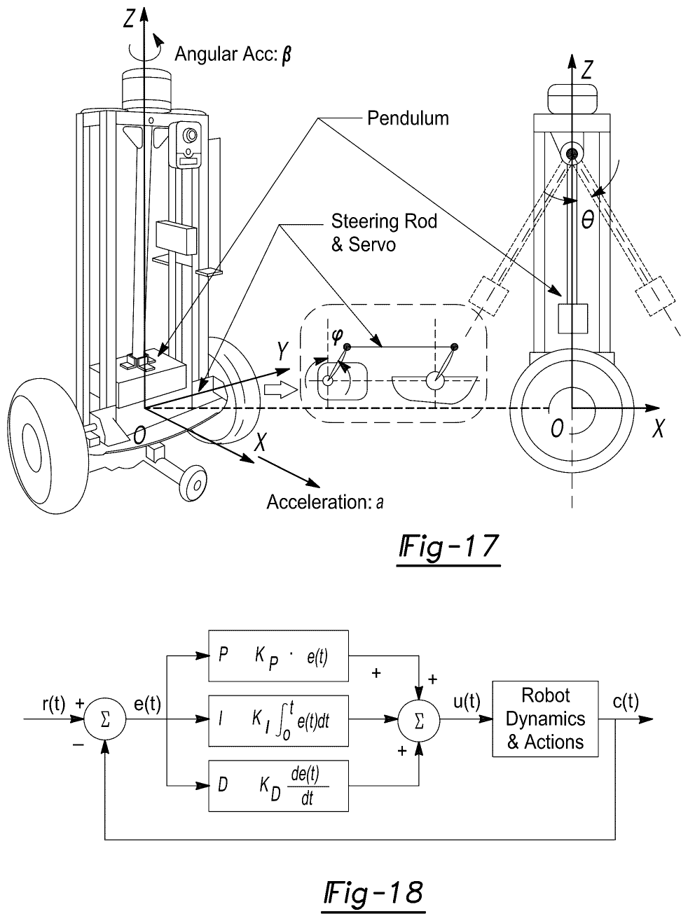

The dynamic model of the robot can be described as a slope-driven pendulum speed control mechanism, as shown in FIG. 17. The velocity and orientation control of the robot were realized through two servos connected to a pendulum and a steering rod. The angle θ in plane XOZ and φ in plane YOZ determine the X direction linear acceleration α and Z direction angular acceleration β. The physical corresponding relationship between these two angles and accelerations can be formulated as:

$$\{ \begin{matrix}α = k {θ}^{2} + p φ = 1. 22 {θ}^{2} + 0 \text{.17} φ \\ β = q φ = 1.05 φ\end{matrix} , α \& β in rad \qquad ( 3.1 )$$

The relationship and coefficients were determined through calibration. We change the pendulum and steering rod to different angles and read the accelerations α and β from the IMU (gyroscope) set on the plane of robot's bed.

With the dynamic and kinematic model of the robot, there is one thing we still need to output the desired velocity and heading precisely, which is the PID controller. The PID controller can provide a closed-loop control system with the velocity and heading feedback from the wheel encoder and IMU (gyroscope). A typical PID controller, which has been implemented to our robot's control system for velocity/orientation control can be described as shown in the flow chart FIG. 18.

With the input of desired speed and orientation and feedback of current kinematic state from IMU and encoder, the more precise control of speed and steer can be generated and output to servos.

### 3.3 Controlling and Sensing

### 3.3.1 Controlling the Robot

After Section 3.2, we already know that we need to output the angle of the two servos to achieve control over the robot. Hence, in this part, the method of how we output the angle command to the servos will be presented.

The servo selected in this disclosure is DS3225 25 KG digital servo. Some useful specifications haven been shown in Table 5.

TABLE 5
Specification of DS3225 25KG digital servo.

| | | |
|---|---|---|
| Operating Voltage | 4.8-6.8 | V |
| Operating Speed | 0.15 sec/60 degree | (5.0 V) |
| | 0.13 sec/60 degree | (6.8 V) |
| Stall Torque | 21 kg/cm | (5.0 V) |
| | 25 kg/cm | (6.8 V) |
| Working Frequency | 50-333 | Hz |
| Working Period | 20000-3003 | μs |

| | |
|---|---|
| Motor Type | DC Motor |

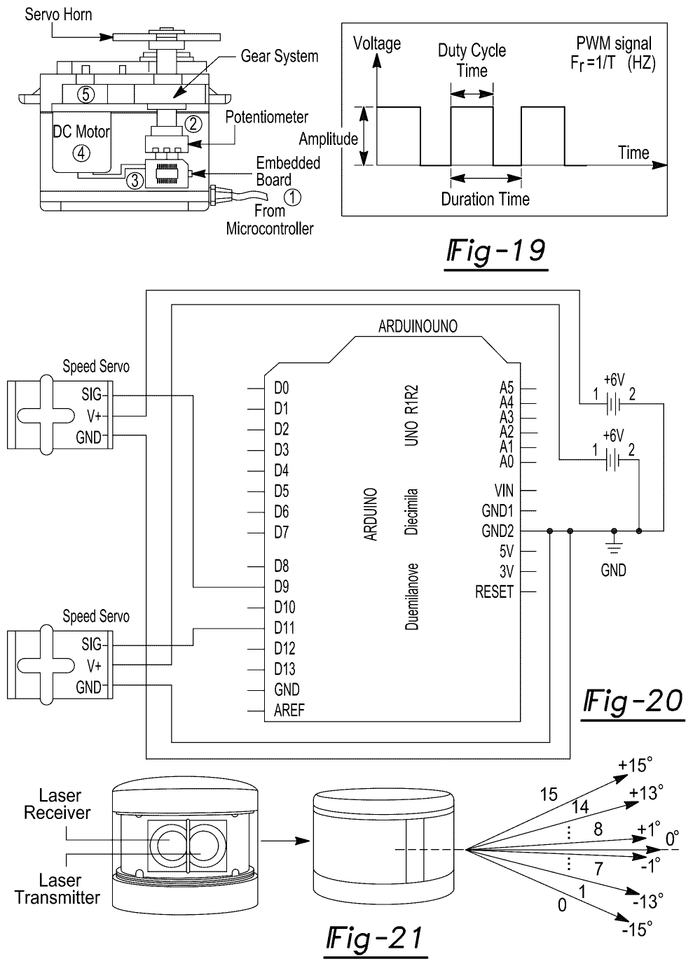

As we all known, the working principle of servo can be simply described in FIG. 19. The angle of servo will vary according to the change of duty cycle, which is called pulse width modulation. In here we chose two servos with working frequency at 50 Hz, working voltage at 6V.

The servo presented has three terminals including signal, power input and ground. Based on the specification and requirements, we chose an Arduino Uno microcontroller to control these two servos. The wire diagram can be simply described in FIG. 20. Each servo has an individual power supply, and they share the same ground with the microcontroller. The PWM control of these servo can be simplified through build-in library from Arduino. The Arduino Uno is then connected to upper system, which is the main frame established through Python 3.6 on Surface.

The library PyFrimata enables the communication between Arduino and Surface. The PWM command was digitized to a number in two decimal places through this library and output to pin #9 and #11. Thus, with the kinematic and dynamic model, we are able to realize the control of velocity and orientation of the robot.

### 3.3.2 Sensing

For LiDAR: The data acquired from LiDAR is called point cloud, which has been introduced in Section 2. In this disclosure, the LiDAR selected is LS 16 Channel LiDAR, and the specification has been shown in Table 6.

TABLE 6
Specification of LS 16 Channel LiDAR.

| Laser Wavelength | 905 | nm |
|---|---|---|
| Maximum Range | 50-70 | m |
| Accuracy | ±3 | cm |
| Angle of Field | Vertical: ±15° | |
| (FOV) | Horizontal: 360° | |
| Resolution of FOV | Vertical: 2° | |
| | Horizontal: 0.09° | |
| Scan Rate | 10 | Hz |

| | |
|---|---|
| Data acquisition | 320000 points/sec |
| Speed | maximum |

The connection between LiDAR and Surface is realized through ethernet and UDP protocol. The origin data pack received from LiDAR has three types including main data stream output protocol (MOP), device information output protocol (DIFOP) and user configuration write protocol (UCWP). Each type of data pack has a length in 1248 bytes and in here we can parse the point cloud data from MOP. After decoding the received data pack, we can collect data in format of {Distance, Azimuth, Intensity, Laser ID, Timestamp}.

TABLE 7
Vertical angles corresponding to laser ID.

| Laser | Vertical |
|---|---|
| ID | Angle |
| 0 | −15° |
| 1 | −13° |
| 2 | −11° |
| 3 | −9° |
| 4 | −7° |
| 5 | −5° |
| 6 | −3° |
| 7 | −1° |
| 8 | +1° |
| 9 | +3° |
| 10 | +5° |
| 11 | +7° |
| 12 | +9° |
| 13 | +11° |
| 14 | +13° |
| 15 | +15° |

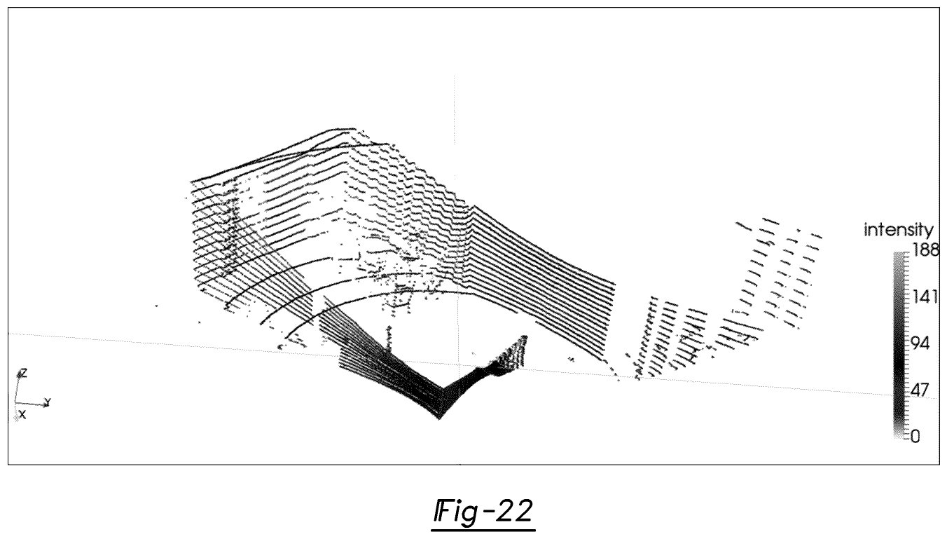

Since we are using a 16 channel LiDAR, the vertical angle of each received points can be determined through FIG. 21 and Table 7. Then we can calculate the 3D information for each point and generate point cloud data in format of
{X, Y, Z, θ, φ, Intensity, Timestamp}

Where θ and φ is the vertical angle and azimuth. Note that we can receive 38400 points each scan in scan frequency of 10 Hz. As the major environment perception mode, the collected point cloud data can be used for obstacle avoidance, data fusion and SLAM. A typical point cloud scan frame captured from LiDAR can be visualized in FIG. 22. The points were colored by order of intensity.

For Camera: This part is pretty simple since the acquisition of images doesn't need too much steps. The camera chose in here, HIKVISION DS-2CD2455FWD-IW is a monocular network camera, and the useful specification has been shown in Table 8.

TABLE 8
Specification of HIKVISION DS-2CD2455FWD-IW camera.

| | |
|---|---|
| Focal Length | 2.8 mm |
| FOV | Horizontal: 97° |
| | Vertical: 54° |
| | Diagonal: 113° |
| Maximum Resolution | 2944 × 1656 |
| Power Supply | 12 V DC, 0.47 A |

The camera was also connected to Surface through ethernet as the same as LiDAR, and the open-source library OpenCV from Python has provided build-in functions to capture images. In this disclosure, the vision information is mainly used for data fusion unlike other vision-driven robots. Hence, the requirement about resolution of images is not so strict which has been chose as 1920×1080. The image can be captured simultaneously with point cloud so that we can perform data fusion later in Section 4.

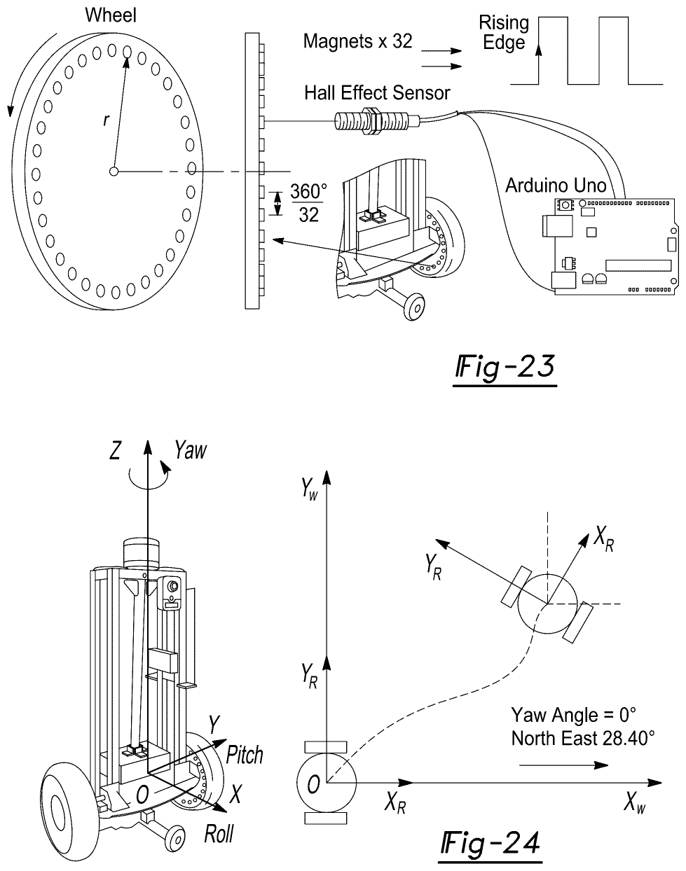

For Wheel Encoder: The wheel encoder implemented on this robot was built on our own. The hardware structure and measurement principle can be described in FIG. 23.

The selected hall effect sensor will generate a pulse when there is a magnet passing by in front of the detecting element of it. We crafted two aluminum plates with 32 magnets evenly and radiatively located on each plate according to the center of the wheel. The plate will rotate as the same speed as the wheel, and this simple system became our wheel encoder. Thus, the key of measuring the wheel speed from this encoder is detecting the rate of rising edge from hall effect sensor. For detecting the rising edge, we connect the hall effect sensor to another Arduino Uno microcontroller and use the digital interrupt pin, which will add the number of pulses detected to the counter automatically. The interrupt interval was set to 0.5 s.

Then with some parameters of the wheel we can calculate the wheel speed and odometry through the following eq.:

$$\{ \begin{matrix}{ω}_{L} = 60 \cdot \frac{2 {n}_{L}}{32} \cdot \frac{2 π}{60} rad / s , \\ {ω}_{R} = 60 \cdot \frac{2 {n}_{R}}{32} \cdot \frac{2 π}{60} rad / s\end{matrix} , \{ \begin{matrix}{v}_{L} = {ω}_{L} r \\ {v}_{R} = {ω}_{R} r\end{matrix} \qquad ( 3.11 )$$

$$\{ \begin{matrix}{O}_{L} = \frac{2 π r}{32} \cdot {n}_{L} \\ {O}_{R} = \frac{2 π r}{32} \cdot {n}_{R}\end{matrix} \qquad ( 3.12 )$$

Where n_{L} and n_{R} is the pulses received at each interrupt interval for left and right wheel, r is the radius of the wheel, O_{L} and O_{R} is the odometer for left and right wheel. Thus, the wheel rotational and linear speed can be read from this encoder directly. After a simple encapsulation, the information read from encode will be sent to the Surface in the form as:

$$\{ S L S {ω}_{L} R S {ω}_{R} {LOO}_{L} {ROO}_{R} E \}$$

Where S, E means starting and ending, LS, RS, LO, RO means rotate speed and odometer from left and right wheel.

Then we simply calibrate the odometer by setting a fixed route as the ground truth, reading the left and right odometer, and taking the mean of multiple tests. The accuracy performs well when using a straight route as it can reach about 98.72%. However, when we try to use the odometer increment to localize the pose of the robot, the accuracy did not achieve the expectation. After many attempts, the reason was found that the rotate speed difference between left and right wheel caused by differential driven mode of SEGWAY while turning must results in an odometer difference. In addition, when the robot is turning around in place, the encoder will still add pulses while the position of the robot is actually not changing. For this kind of situation, a correction factor was added as shown in the eq.:

$$O = \vert {O}_{L} - {O}_{R} \vert / 2 \cdot {k}_{o} , {k}_{o} = \{ \begin{matrix}0.95 , & \frac{\vert {v}_{L} - {v}_{R} \vert}{{v}_{L} + {v}_{R}} ∈ ( 0 , 0.4 ) \\ 0.5 , & \frac{\vert {v}_{L} - {v}_{R} \vert}{{v}_{L} + {v}_{R}} ∈ [ 0.4 , 0.75 ) \\ 0.2 , & \frac{\vert {v}_{L} - {v}_{R} \vert}{{v}_{L} + {v}_{R}} \geq 0.75\end{matrix} \qquad ( 3.13 )$$

The classification of correction factor kₒ represents the speed difference between left and right wheel, and it was determined by calibration through many tests. Thus, new odometer can be used to positioning the robot together with the IMU.

For IMU: This part is pretty simple as for camera. The IMU used in here is WitMotion WT901C-485, a 9-axis inertial measurement unit, or called gyroscope. The measurement principle of IMU is not under discussion of this disclosure, so in here we just briefly introduce the implementation and how we combine the information from encoder together to determine the pose of the robot. The roll, pitch and yaw axis of IMU can be described in FIG. 24.

The IMU is connected to the Surface through USB, and we can read the linear acceleration, angle, and angular speed for each axis individually. Note that the yaw angle read from IMU has an absolute zero which corresponds to 28.40°, northeast. Then with the kinematic model mentioned before and odometer read from encoder simultaneously, we can determine the position of the robot through eq:

$$\{ \begin{matrix}{X}_{t} = {X}_{t - 1} + \frac{Δ O}{2} \cdot {k}_{o} \cdot cos θ \\ {Y}_{t} = {Y}_{t - 1} + \frac{Δ O}{2} \cdot {k}_{o} \cdot sin θ\end{matrix} \qquad ( 3.14 )$$

Where ΔO=|O_{L}−O_{R}|ₜ−|O_{L}−O_{R}|ₜ₋₁ is the increment of odometer. Also, the linear acceleration for three axes can be used in obstacle avoidance, which will be introduced in detail in Section 3.5.1.

### 3.4 Software System Framework

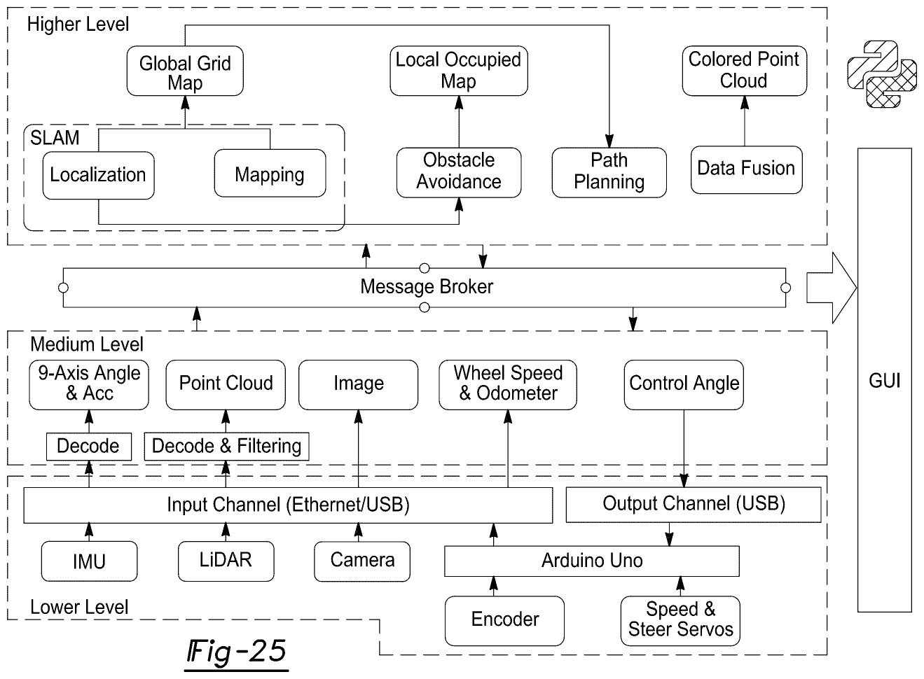

Instead of using robot operating system (ROS) as most of robots do, we build the whole system based on Python 3.6. The software system structure can be described as the flow chart in FIG. 25.

As shown in FIG. 25, there are three levels including higher, medium, and lower level, which are connected by I/O channels and a message broker. The lower level concludes the I/O channel, sensors, and actuators. The mission of this level is perception and action. The collected data from sensors will be streamed to medium level for decoding and pre-processing, while the action commands came from upper levels will be executed. After receiving data from lower level, the medium level will decode and pre-process the data such as filtering, transformation e.g., and publish the processed data to the message broker. Also, the command and decision sent from higher level will be transformed into PWM which can be executed directly by servos. In here, users can read the data straightly from the message broker. The higher level concludes the presented four main functions, Obstacle avoidance, SLAM, path planning and data fusion. The main objective of this level is to realize these functions by subscribing the data published on message broker. This is convenient because one kind of data can be useful for different functions. For example, the roll-pitch-yaw angle read from IMU can be used both for SLAM and obstacle avoidance simultaneously. In addition, the message broker can be essential for ensuring the synchronism of collected data. Finally, some results and information such as global grid map, local occupied map, and colored point cloud will be generated by higher level and pass to message broker to be presented to users. Meanwhile, the robot will act autonomously such as self-exploring the environment.

### 3.5 Function Realization

### 3.5.1 Obstacle Avoidance (2D-LiDAR Occupied Grid Mapping)

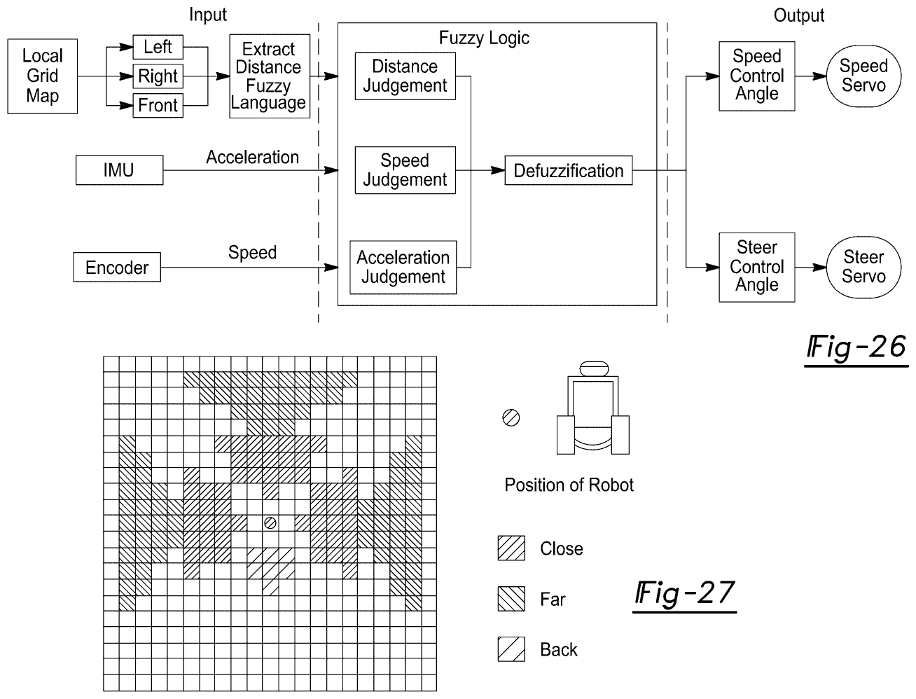

The flow chart of obstacle avoidance function has been shown in FIG. 26. The basic logic of this function can be described as random self-exploring with obstacle avoidance, while the action principle can be described as a 2D-LiDAR occupied grid mapping and kinematic driven fuzzy logic algorithm.

As shown in FIG. 26, the input of this function includes a 2D grid map generated by LiDAR, wheel speed read from encoder, angles and acceleration read from IMU. After a fuzzy logic judgement mode, the desired control command including speed and steer will be generated and pass to the two servos corresponded. The implication of fuzzy language variables has been defined as:
Distance: {Far, Close}
Current Speed: {Fast, Slow}
Steering: {Left, Front, Right}
Acceleration: {BN, SN, Z, SP, BP}, {Big Negative, Small Negative, Zero, Small Positive, Big Positive}

In there, the definition of left, right, and front distance has been shown in FIG. 27. The grid size of local map has been set to 0.3 m, which is close to the size of the robot, and the map size has been set to 3×3 m. The center of the local grid map is the current position of the robot, while the current heading of robot was set to be the same as the north in global. With the implication of fuzzy language variables, we defined 50 rules as the reference for guiding the action of robot, as shown in Table 9. Thus, the next step is to generate the 2D grid map as the perception, and define the control amount of the robot.

Note that, to generate the 2D local grid map, there is still another data pre-processing step implemented in order to reduce computation load and increase running speed. As mentioned before, the format of point cloud data received from LiDAR is generalized as:
{X, Y, Z, θ, φ, Intensity, Timestamp}

But in this function, the only useful information is the X, Y coordinates. Besides, the construction of local map will only focus on points within 3×3 m. Thus, we first extract the X, Y coordinate and delete all points over 3×3 m. Then, for each grid on the map, we count the number of points within the coordinate and set a confidence threshold to eliminate outlies.

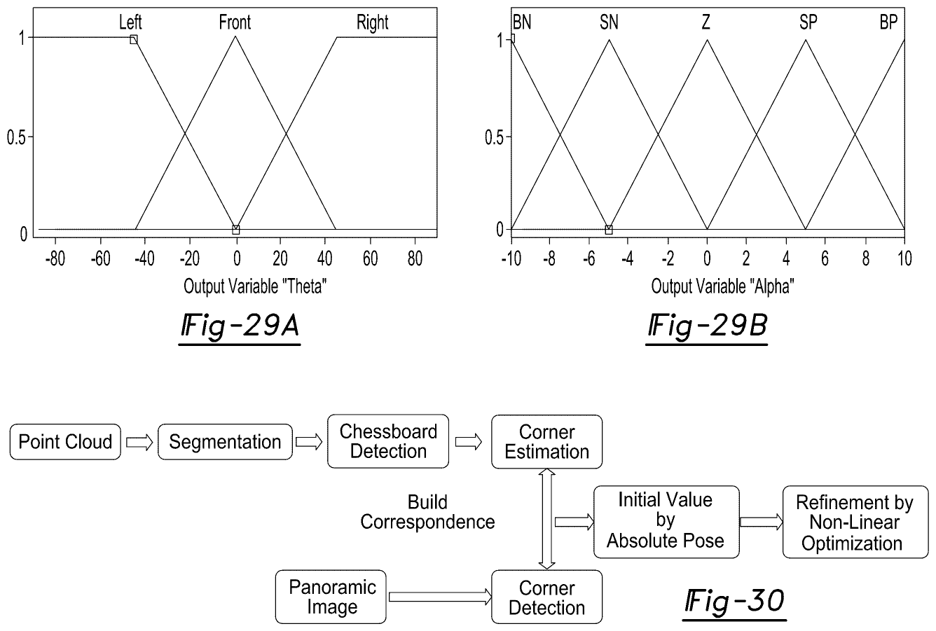

With the local grid map, wheel speed, and acceleration, we are able to determine the fuzzy membership of input variables. In here we chose continuous and triangle-shaped domain function as the membership function of each input variable, as shown in FIGS. 28A-28E and FIGS. 29A-29B.

TABLE 9
Fuzzy logic rule sets.

| Rule | Input | | | | | Output | |
|---|---|---|---|---|---|---|---|
| Number | LD | FD | RD | α | ν | α | θ |
| 1 | Far | Far | Far | BN | Fast | SP | Front |
| 2 | Far | Far | Far | BN | Slow | BP | Front |
| 3 | Far | Far | Far | BP | Fast | SN | Front |
| 4 | Far | Far | Far | BP | Slow | Z | Front |
| 5 | Far | Far | Far | Z | Fast | Z | Front |
| 6 | Far | Far | Far | Z | Slow | SP | Front |
| 7 | Far | Far | Far | SP | Fast | SN | Front |
| 8 | Far | Far | Far | SP | Slow | Z | Front |
| 9 | Far | Far | Far | SN | Fast | Z | Front |
| 10 | Far | Far | Far | SN | Slow | Z | Front |
| 11 | Close | Close | Close | BN | Fast | BN | Front |
| 12 | Close | Close | Close | BN | Slow | SN | Front |
| 13 | Close | Close | Close | BP | Fast | BN | Front |
| 14 | Close | Close | Close | BP | Slow | BN | Front |
| 15 | Close | Close | Close | Z | Fast | BN | Front |
| 16 | Close | Close | Close | Z | Slow | SN | Front |
| 17 | Close | Close | Close | SP | Fast | BN | Front |
| 18 | Close | Close | Close | SP | Slow | BN | Front |
| 19 | Close | Close | Close | SN | Fast | BN | Front |
| 20 | Close | Close | Close | SN | Slow | SN | Front |
| 21 | Close | Far | Far | BN | Fast | SP | Front |
| 22 | Close | Far | Far | BN | Slow | BP | Front |
| 23 | Close | Far | Far | BP | Fast | SN | Front |
| 24 | Close | Far | Far | BP | Slow | Z | Front |
| 25 | Close | Far | Far | Z | Fast | Z | Front |
| 26 | Close | Far | Far | Z | Slow | SP | Front |
| 27 | Close | Far | Far | SP | Fast | SN | Front |
| 28 | Close | Far | Far | SP | Slow | Z | Front |
| 29 | Close | Far | Far | SN | Fast | Z | Front |
| 30 | Close | Far | Far | SN | Slow | Z | Front |
| 31 | Far | Close | Far | BN | Fast | BN | Right |
| 32 | Far | Close | Far | BN | Slow | SN | Right |
| 33 | Far | Close | Far | BP | Fast | BN | Right |
| 34 | Far | Close | Far | BP | Slow | BN | Right |
| 35 | Far | Close | Far | Z | Fast | BN | Right |
| 36 | Far | Close | Far | Z | Slow | SN | Right |
| 37 | Far | Close | Far | SP | Fast | BN | Right |
| 38 | Far | Close | Far | SP | Slow | BN | Right |
| 39 | Far | Close | Far | SN | Fast | BN | Right |
| 40 | Far | Close | Far | SN | Slow | SN | Right |
| 41 | Far | Far | Close | BN | Fast | SP | Left |
| 42 | Far | Far | Close | BN | Slow | BP | Left |
| 43 | Far | Far | Close | BP | Fast | SN | Left |
| 44 | Far | Far | Close | BP | Slow | Z | Left |
| 45 | Far | Far | Close | Z | Fast | Z | Left |
| 46 | Far | Far | Close | Z | Slow | SP | Left |
| 47 | Far | Far | Close | SP | Fast | SN | Left |
| 48 | Far | Far | Close | SP | Slow | Z | Left |
| 49 | Far | Far | Close | SN | Fast | Z | Left |
| 50 | Far | Far | Close | SN | Slow | Z | Left |

### 3.5.2 Sensor Data Fusion

This part can be separated into two main steps, starting from LiDAR and camera, as shown in FIG. 30. The first one is to co-calibrate the LiDAR and camera to obtain intrinsic and extrinsic matrices for both. With the extrinsic matrix, the geometric transformations (rotation R and translation T) can be solved to correlate the point cloud and image frame together in a same coordinate.

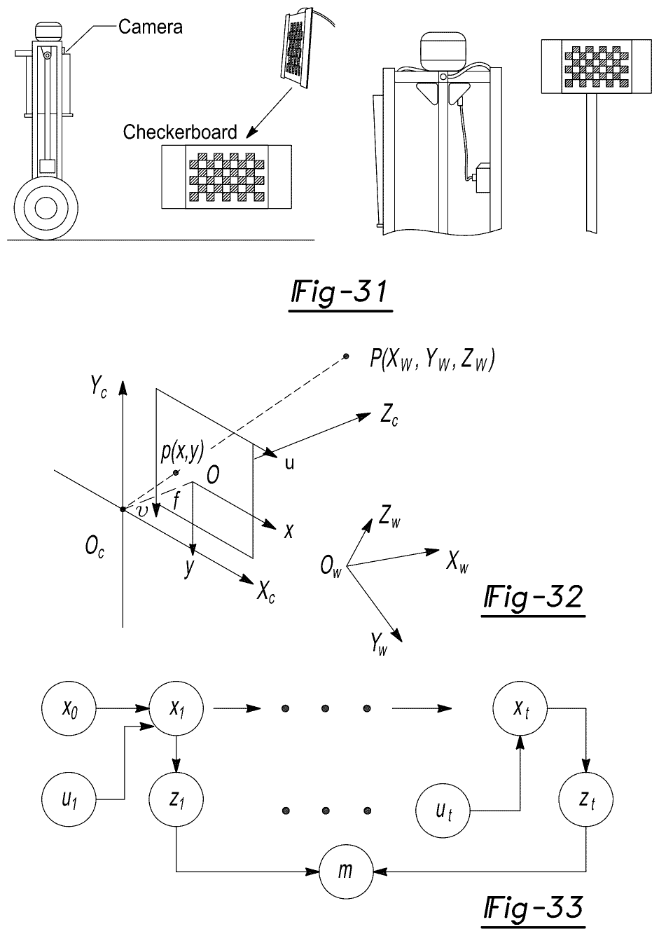

For calibrating the camera, the traditional method is used, which enquires a checkerboard in size of 6×9, and each checker is 10×10 mm, as shown in FIG. 31. The resolution of images captured for calibration is 1920×1080 and one image set contains 20 images captured while the checkerboard was at different angles and positions.

The traditional camera calibration method presented in this disclosure can be summarized as a process of establishing the relationship between the real world and the pixel coordinate which can be quantified and programmed. In FIG. 32, all the three coordinates participated in this process were identified in different colors. The red one is the camera coordinate, in here we use O_{c}−X_{c}Y_{c}Z_{c} to represent. The green one is the image coordinate (or pixel coordinate) o−xy. The yellow one is the real-world coordinate O_{w}−X_{w}Y_{w}Z_{w}. The relationship between these coordinates are some translation and rotation transformations and a physical principle called pinhole imaging principle, as shown in FIG. 32. Overall, the transformation from image coordinate to world coordinate can be represented by two matrices, which are the alleged intrinsic and extrinsic matrices.

$${Z}_{c} [ \begin{matrix}u \\ v \\ 1\end{matrix} ] = [ \begin{matrix}\frac{1}{dx} & 0 & {u}_{0} \\ 0 & \frac{1}{dy} & {v}_{0} \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}R & T \\ \vec{0} & 1\end{matrix} ] [ \begin{matrix}{X}_{w} \\ {Y}_{w} \\ {Z}_{w} \\ 1\end{matrix} ] = [ \begin{matrix}{f}_{x} & 0 & {u}_{0} & 0 \\ 0 & {f}_{y} & {v}_{0} & 0 \\ 0 & 0 & 1 & 0\end{matrix} ] [ \begin{matrix}R & T \\ \vec{0} & 1\end{matrix} ] [ \begin{matrix}{X}_{w} \\ {Y}_{w} \\ {Z}_{w} \\ 1\end{matrix} ] \qquad ( 3.15 )$$

Where f is the focal length of the camera, Z_{c} is the scale factor, u₀ and v₀ are the principle points. The matrix

$$[ \begin{matrix}{f}_{x} & 0 & {u}_{0} & 0 \\ 0 & {f}_{y} & {v}_{0} & 0 \\ 0 & 0 & 1 & 0\end{matrix} ]$$

is called the intrinsic matrix and

$$[ \begin{matrix}R & T \\ \vec{0} & 1\end{matrix} ]$$

is called the extrinsic matrix.

Now by extracting the corner of checkers in the image set captured from our robot, we can obtain the coordinate of the same corner from different images. From this process the intrinsic matrix can be determined, which will be presented as the calibration result in Section 4.

As mentioned before, the key about fusing data from camera and LiDAR is to establish the translation and rotation relationship between them accurately. With the calibrated image, the next step is to place each coordinate from the sensors itself together in a same coordinate. Given the LiDAR point cloud coordinate P_{L}=(X_{L} Y_{L} Z_{L}) and the camera coordinate P_{c}=(X_{c} Y_{c} Z_{c}), the geometric transformation can be determined as

$$[ \begin{matrix}{X}_{c} \\ {Y}_{c} \\ {Z}_{c}\end{matrix} ] = R [ \begin{matrix}{X}_{L} \\ {Y}_{L} \\ {Z}_{L}\end{matrix} ] + T \qquad ( 3.16 )$$

where the R and T are the same as the rotation and translation matrices. The translation matrix T=[tₓ, t_{y}, t_{z}]^{T} is a 3×1 column vector, and rotation matrix R can be determined with three rotation angles {θₓ, θ_{y}, θ_{z}} correlated to the coordinate axes:

$$\begin{matrix}R = {R}_{z} ( {θ}_{z} ) {R}_{y} ( {θ}_{y} ) {R}_{x} ( {θ}_{x} ) \\ {R}_{x} ( {θ}_{x} ) = [ \begin{matrix}1 & 0 & 0 \\ 0 & cos ( {θ}_{x} ) & - sin ( {θ}_{z} ) \\ 0 & sin ( {θ}_{x} ) & cos ( {θ}_{x} )\end{matrix} ] \\ {R}_{y} ( {θ}_{y} ) = [ \begin{matrix}cos ( {θ}_{y} ) & 0 & sin ( {θ}_{y} ) \\ 0 & 1 & 0 \\ - sin ( {θ}_{y} ) & 0 & cos ( {θ}_{y} )\end{matrix} \\ {R}_{z} ( {θ}_{z} ) = [ \begin{matrix}cos ( {θ}_{z} ) & - sin ( {θ}_{z} ) & 0 \\ sin ( {θ}_{z} ) & cos ( {θ}_{z} ) & 0 \\ 0 & 0 & 1\end{matrix} ]\end{matrix} \qquad ( 3.17 )$$

Then the point in real world that has being three-dimensional P_{c}=(X_{c} Y_{c} Z_{c}) can be back projected onto the image plane in coordinate p=(u, v). From the pinhole imaging principle that has been mentioned before, the projection equation in homogeneous coordinate can be formulated as:

$$s [ \begin{matrix}u \\ v \\ 1\end{matrix} ] = K {P}_{c} = [ \begin{matrix}{f}_{x} & 0 & {u}_{0} & 0 \\ 0 & {f}_{y} & {v}_{0} & 0 \\ 0 & 0 & 1 & 0\end{matrix} ] [ \begin{matrix}{X}_{c} \\ {Y}_{c} \\ {Z}_{c} \\ 1\end{matrix} ] \qquad ( 3.18 )$$

Where s is the scale factor, (fₓ, f_{y}) and (u₀, v₀) are the same as the focal lengths and principal point.

To obtain better result of data fusion, the radial distortion caused by lens aberration should also be considered. Similar to, we use two distortion parameters k₁ and k₂ to characterize the radial distortions. Then the distortion corrected projection can be formulated as:

$$\tilde{u} = u + ( u - {u}_{0} ) [ {k}_{1} ( {X}_{c}^{2} + {Y}_{c}^{2} ) + {{k}_{2} ( {X}_{c}^{2} + {Y}_{c}^{2} )}^{2} ] \qquad ( 3.19 )$$

$$\tilde{v} = v + ( v - {v}_{0} ) [ {k}_{1} ( {X}_{c}^{2} + {Y}_{c}^{2} ) + {{k}_{2} ( {X}_{c}^{2} + {Y}_{c}^{2} )}^{2} ] \qquad ( 3.2 )$$

where \tilde{p}=(ũ, \tilde{v}) is a distorted point and p=(u, v) a pixel on a undistorted image.

Now since the projection equation of placing 3D point cloud onto the image plane has been deduced through, the next step is to estimate the extrinsic parameters {θₓ, θ_{y}, θ_{z}, tₓ, t_{y}, t_{z}} and distortion parameters {k₁, k₂}. We still use the 6×9×10 checkerboard as the landmark, and the corner of each checker will be the target point for projection. The corners in 3D point cloud P_{L} will be projected onto the 2D image points \tilde{p} to calculate the absolute difference between these and the real corners p* in image. Then the estimation of extrinsic and distortion parameters can be derived by minimizing the cost function as followed:

$$C = {\sum }_{i = 1}^{n} \vert {p}_{i}^{*} - {\tilde{p}}_{i} \vert \qquad ( 3.21 )$$

where i is the point index and n is the total number of points.

For extracting the corners from the 3D point cloud, there are two keys insisted in this disclosure. The first one is to use the geometrical features to find the dimension of the checkerboard in 3D point cloud. The second one is using the different LIDAR reflection of the white and black blocks on the checkerboard.

At last, with the estimated intrinsic and extrinsic matrices, the 3D-2D correspondences between the 3D point cloud and the 2D image for data fusion can be determined.

### 3.5.3 2D SLAM

As mentioned before, the localization and mapping are one of the most essential part of an autonomous robot. In here the methodology and process of how we implement 2D SLAM function to our robot will be introduced in detail.

Based on the uncertainty of movement control and observation, the SLAM problem can be described as a kind of Markov Decision Process (MDP), more specifically as a Partially Observable Markov Decision Process (POMDP), as shown in FIG. 33. In here, the circles represent:
xₜ: the actual pose of robot.
uₜ: the movement command sent to robot.
zₜ: the observation of environment from sensor.
m: the actual map or description of real world or environment.

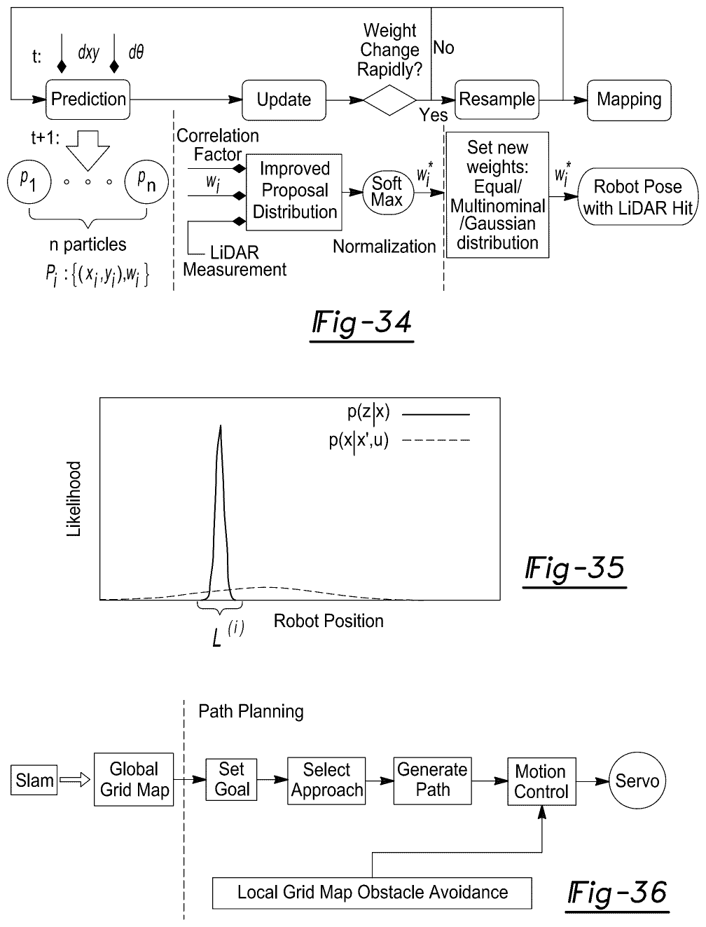

The theoretical structure chart of 2D SLAM has been shown in FIG. 34. Since the SLAM algorithm presented in this disclosure is based on particle filter, the whole SLAM process can be described as a probabilistic distribution problem about solving the joint probability density of the probability of robot's current position. As illustrated in eq.:

$$p ( {x}_{1 : t} , m \vert {z}_{1 : t} , {u}_{1 : t - 1} ) \qquad ( 3.22 )$$

Where x_{1:t} is the trajectory of robot, m is the global map, z_{1:t} is the observation from sensors (in here we use LiDAR 2D point cloud, wheel encoder odometer and IMU angles), u_{1:t-1} is the movement control command.

Based on Rao-Blackwellized Particle Filter specifically, we split the SLAM into localization and mapping these two processes, so that the joint probability density can be factorized into ( ) through Joint probability formula as:

$$p ( {x}_{1 : t} , m \vert {z}_{1 : t} , {u}_{1 : t - 1} ) = p ( m \vert {x}_{1 : t} , {u}_{1 : t - 1} ) \cdot p ( {x}_{1 : t} \vert {z}_{1 : t} , {u}_{1 : t - 1} ) \qquad ( 3.23 )$$

Where p(x_{1:t}|z_{1:t}, u_{1:t-1}) is the posterior probability distribution of robot's trajectory at certain known sensor observation and control command. Note that (z_{1:t}, u_{1:t-1}) can be considered as the potential trajectories, and the particle filter can be applied in solving this posterior. By solving this posterior, the estimated current pose of the robot can be determined, which means the localization has been done.

The SLAM framework can be presented as a cycle with three main steps. The first one is called prediction or sampling. The input of this step insists the change of angle dθ and pose (dx, dy) at time t, which can be read directly from gyroscope and odometer. With these inputs a certain number of particles in form of {(xᵢ, yᵢ), wᵢ} at time t+1 will be generated to represent the estimated positions where the robot will probably appear. The weight of these particles wᵢ, which represents the difference between target distribution and proposal distribution, will be given under the principle of importance sampling:

$${w}_{i} = \frac{p ( {x}_{1 : t} \vert {z}_{1 : t} , {u}_{1 : t - 1} )}{π ( {x}_{1 : t} \vert {z}_{1 : t} , {u}_{1 : t - 1} )} \qquad ( 3.24 )$$

$$π ( {x}_{1 : t} \vert {z}_{1 : t} , {u}_{1 : t - 1} ) = π ( {x}_{t} \vert {x}_{1 : t - 1} , {z}_{1 : t} , {u}_{1 : t - 1} ) \cdot π ( {x}_{1 : t - 1} \vert {z}_{1 : t - 1} , {u}_{1 : t - 2} ) \qquad ( 3.25 )$$

Since the main observation sensor is LiDAR, we use proposal distribution π(x_{1:t}|z_{1:t}, u_{1:t-1}) instead of target distribution because the computing amount of point cloud data is too heavy, which cannot be modeled directly. In other words, the target distribution cannot be calculated even nearly. This proposal distribution can be determined through a recursive formulation. Then the weight is calculated as:

$$\begin{matrix}{w}_{i} = \frac{p ( {x}_{1 : t} \vert {z}_{1 : t} , {u}_{1 : t - 1} )}{π ( {x}_{1 : t} \vert {z}_{1 : t} , {u}_{1 : t - 1} )} \\ = \frac{η p ( {z}_{t} \vert {x}_{1 : t} , {z}_{1 : t - 1} ) \cdot p ( {x}_{t} \vert {x}_{t - 1} , {u}_{t - 1} )}{π ( {x}_{t} \vert {x}_{1 : t - 1} , {z}_{1 : t} , {u}_{1 : t - 1} )} . \frac{p ( {x}_{1 : t - 1} \vert {z}_{1 : t - 1} , {u}_{1 : t - 2} )}{π ( {x}_{1 : t - 1} \vert {z}_{1 : t - 1} , {u}_{1 : t - 2} )} \\ ∝ \frac{p ( {z}_{t} \vert {m}_{t - 1} , {x}_{t} ) \cdot p ( {x}_{t} \vert {x}_{t - 1} , {u}_{t - 1} )}{π ( {x}_{t} \vert {x}_{1 : t - 1} , {z}_{1 : t} , {u}_{1 : t - 1} )} \cdot {w}_{t - 1}\end{matrix} \qquad ( 3.26 )$$

$$η = \frac{1}{p ( {z}_{t} \vert {z}_{1 : t - 1} , {u}_{1 : t - 1} )}$$

is a normalization factor resulting from Bayes' rule that is equal for all particles.

To improve the accuracy of the localization and mapping processes, we add the most recent observation from sensor zₜ when generating the next generation of samples. This is because the sensor information, especially from LiDAR, is more precise than the motion estimate of the robot based on the odometry, as shown in FIG. 35, where L⁽ⁱ⁾ is the likelihood. By integrating sensor observation zₜ into the proposal distribution, the sampling will be focused on the meaningful regions of the observation likelihood. The distribution after adding zₜ becomes:

$$p ( {x}_{t} \vert {m}_{t - 1} , {x}_{t - 1} , {z}_{t} , {u}_{t - 1} ) = \frac{p ( {z}_{t} \vert {m}_{t - 1} , {x}_{t} ) p ( {x}_{t} \vert {x}_{t - 1} , {u}_{t - 1} )}{p ( {z}_{t} \vert {m}_{t - 1} , {x}_{t - 1} , {u}_{t - 1} )} \qquad ( 3.27 )$$

Using this optimal improved proposal distribution, the computation of weights turns into:

$$\begin{matrix}{w}_{t} = {w}_{t - 1} \frac{η p ( {z}_{t} \vert {m}_{t - 1} , {x}_{t} ) p ( {x}_{t} \vert {x}_{t - 1} , {u}_{t - 1} )}{p ( {x}_{t} \vert {m}_{t - 1} , {x}_{t - 1} , {z}_{t} , {u}_{t - 1} )} \\ ∝ {w}_{t - 1} \frac{p ( {z}_{t} \vert {m}_{t - 1} , {x}_{t} ) p ( {x}_{t} \vert {x}_{t - 1} , {u}_{t - 1} )}{p ( {z}_{t} \vert {m}_{t - 1} , {x}_{t} ) p ( {x}_{t} \vert {x}_{t - 1} , {u}_{t - 1} ) / p ( {z}_{t} \vert {m}_{t - 1} , {x}_{t - 1} , {u}_{t - 1} )} \\ = {w}_{t - 1} \cdot p ( {z}_{t} \vert {m}_{t - 1} , {x}_{t - 1} , {u}_{t - 1} ) \\ = {w}_{t - 1} \cdot \int p ( {z}_{t} \vert {x}^{′} ) p ( {x}^{′} \vert {x}_{t - 1} , {u}_{t - 1} ) {dx}^{′}\end{matrix} \qquad ( 3.28 )$$

As mentioned before, when modeling the environment with grid maps, a closed form approximation of an informed proposal distribution cannot be achieved directly due to the heavy amount of computation from laser sensor. But in here we can use sampling to reach the approximated form of the improved proposal. As shown in the framework in FIG. 34, the first step is to sample a set of potential poses x; from the motion model p(xₜ|xₜ₋₁, uₜ₋₁). Note that if the observation likelihood is peaked, the number of pose samples is high since a dense sampling is needed for covering all the small areas of high likelihood. This will lead to a high number of particles, which means high amount of computation.

The method to solve this problem is that the meaningful area of the observation likelihood will be determined through a scan-matcher firstly, then the sampling will occur only in this meaningful area. For each particle i, the Gaussian parameters including mean μₜⁱ and variance Σₜⁱ will be estimated individually for K sampled poses {xⱼ} in interval L⁽ⁱ⁾:

$${μ}_{t}^{i} = \frac{1}{{η}^{i}} \cdot {\sum }_{j = 1}^{K} {x}_{j} \cdot p ( {z}_{t} \vert {m}_{t - 1} , {x}_{j} ) \cdot p ( {x}_{j} \vert {x}_{t - 1} , {u}_{t - 1} ) \qquad ( 3.29 )$$

$${Σ}_{t}^{i} = \frac{1}{{η}^{i}} \cdot {\sum }_{j = 1}^{K} p ( {z}_{t} \vert {m}_{t - 1} , {x}_{j} ) \cdot p ( {x}_{j} \vert {x}_{t - 1} , {u}_{t - 1} ) \cdot ( {x}_{j} - {μ}_{t} ) {( {x}_{j} - {μ}_{t} )}^{T} \qquad ( 3.3 )$$

with the normalization factor:

$${η}^{i} = {\sum }_{j = 1}^{K} p ( {z}_{t} \vert {m}_{t - 1} , {x}_{j} ) \cdot p ( {x}_{j} \vert {x}_{t - 1} , {u}_{t - 1} ) \qquad ( 3.31 )$$

Finally, the closed form approximation of the optimal proposal is obtained to generate the next generation of particles. Note that the weights will be calculated by using this proposal distribution as:

$$\begin{matrix}{w}_{t} = {w}_{t - 1} \cdot p ( {z}_{t} \vert {m}_{t - 1} , {x}_{t - 1} , {u}_{t - 1} ) \\ = {w}_{t - 1} \cdot \int p ( {z}_{t} \vert {m}_{t - 1} , {x}^{′} ) \cdot p ( {x}^{′} \vert {x}_{t - 1} , {u}_{t - 1} ) d x \\ ≃ {w}_{t - 1} \cdot {\sum }_{j = 1}^{K} p ( {z}_{t} \vert {m}_{t - 1} , {x}_{j} ) \cdot p ( {x}_{j} \vert {x}_{t - 1} , {u}_{t - 1} ) \\ = {w}_{t - 1} \cdot {η}^{i}\end{matrix} \qquad ( 3.32 )$$

These weights will also be normalized through a SoftMax and become [symbol] . Now with these weighted particles, we are able to determine the location of the robot. As shown in the framework in FIG. 34, we can transform the current 2D lase hit to the mapping coordinate with the current pose as the center to construct the map. The transformation matrix from LiDAR to robot's body frame is:

$${R}_{L - b} = [ \begin{matrix}cos {θ}_{n} cos {θ}_{h} & - sin {θ}_{n} & cos {θ}_{n} sin {θ}_{h} & 0 \\ sin {θ}_{n} cos {θ}_{h} & cos {θ}_{n} & sin {θ}_{n} sin {θ}_{h} & 0 \\ sin {θ}_{h} & 0 & cos {θ}_{h} 0 & \\ 0 & 0 & 01 & \end{matrix} ] \qquad ( 3.33 )$$

where θₙ is neck angle and θₕ is head angle.

The transformation matrix from robot's body frame to global map is:

$${R}_{b - G} = [ \begin{matrix}1 & 0 & 0 & x \\ 0 & 1 & 0 & y \\ 0 & 0 & 1 & z \\ 0 & 0 & 0 & 1\end{matrix} ] \cdot [ \begin{matrix}cos {θ}_{yaw} & - sin {θ}_{yaw} & 0 & 0 \\ sin {θ}_{yaw} & cos {θ}_{yaw} & 0 & 0 \\ 0 & \begin{matrix}0 & 1 & 0\end{matrix} & & \\ 0 & \begin{matrix}0 & 0 & 1\end{matrix} & & \end{matrix} ] \cdot [ \begin{matrix}cos {θ}_{pitch} & 0 & sin {θ}_{pitch} & 0 \\ 0 & 1 & 0 & 0 \\ - sin {θ}_{pitch} & 0 & cos {θ}_{pitch} & 0 \\ 0 & 0 & 0 & 1\end{matrix} ] [ \begin{matrix}1 & 0 & 0 & 0 \\ 0 & cos {θ}_{r o l l} & - sin {θ}_{r o l l} & 0 \\ 0 & sin {θ}_{r o l l} & cos {θ}_{r o l l} & 0 \\ 0 & 0 & 0 & 1\end{matrix} ] \qquad ( 3.34 )$$

where θ_{yaw}, θₚᵢₜₕ, and θᵣₒₗₗ correspond to the yaw, pitch and roll read from IMU, x, y, z is the trajectory of the robot.

Also, since the equipped 16-channel LiDAR can provide 38400 points each scan, some operations was added to de-noise and decrease density for the point cloud data. A threshold will be set to remove those point cloud hit on the ground at the beginning as one of the data pre-processing operations.

After each loop, there will be a judgement to assess the quality of our particles for deciding whether the resampling is necessary. In resampling step, those particles with low importance weights wₜ will be replaced by particles with higher weights. This step can make sure that the overall number of particles will remain finitely since we do not want too many particles to retard the running speed. On the contrary, resampling may also remove good samples from the filter which can lead to particle impoverishment. In that case, there is no doubt that this judgement step (or as people called “adaptive resampling”) is necessary to find a criterion for deciding when to perform the resampling step. The index representing the effective sample size to estimate how well the current particle set represents the target posterior was introduced, and in here this quantity was calculated according to the formulation of Doucet as

$${N}_{eff} = \frac{1}{{\sum }_{i = 1}^{N} {( {\tilde{w}}^{i} )}^{2}} \qquad ( 3.35 )$$

If the sample were drawn from the target distribution, their importance weights would be equal to each other due to the importance sampling principle. The worse the approximation of the target distribution, the higher is the variance of the importance weights. The threshold of resampling was set at N/2, which means the resampling will occur when N_{eff} dropped below half number of particles at each time.

Then with the transformed 2D lase hits, the occupied grid will be generated and updated through every circulation to ensure the whole function is real time.

### 3.5.4. Path Planning

In this disclosure, the scenario of implementing path planning can be described and classified as dynamic, global, and exact. The working principle of this function is based on a constructed global map, which is actually streamed from SLAM function as the output.

The pipeline of path planning process can be described in FIG. 36. As mentioned before, the SLAM function will pass the constructed global occupied grid map to path planning function as a perception of the environment. The resolution of the occupied map has been set on 20 cells/m, and the size of the map is 30×30 m.

Then, the grid map will be transformed to another grid map on the same size and resolution for path planning according to the different colors on the map. Table 10 has shown the meaning corresponding to different colors.

TABLE 10
Meanings corresponding to different
colors on map for path planning.

| Color | Meaning |
|---|---|
| Black | Obstacle |
| White | Free Space |
| Red | Visited |
| Blue | Final Path |
| Light Blue | Save Zone |
| Pink | Dangerous |
| | Zone |

The user will be asked to select a destination on white grids. The current location will also be passed from SLAM as the default start point. The save zone and dangerous zone has been set along the edge of the obstacles. The size of save zone is 3 grids while the size of dangerous zone is 2 grids. Note that the purpose of setting save zone and dangerous zone is to leave enough redundancy for safety concern.

Once the path planning function has been activated, the robot will be ordered to stop and wait for command. Users can select the method of planning path at the beginning including:
A Star (A*)
A Star Heuristic
Dijkstra
Greedy Approach
Heuristic Weighted
Reinforcement Learning

The principle of these mentioned path planning method has been introduced in Section 2, so in here we just code them into our function. No matter the method under selected, the path will be translated into a set of command and send to servos to drive the robot from start to destination. In here, due to the time limitation, we presented a closed-loop control to ensure the robot was led to the right destination with the feedback from wheel encoder (speed) and SLAM (trajectory), but we did not implement the closed-loop control in this part. FIG. 37 presents an example of translating path to commands. The green grid is the start point, while the yellow grid is the destination. The current pose of robot is heading the front of the south, so that the command will be:
F&SP, L&SP, F&SP, F&SN, F&Z, R&SP, F&SP, F&SN, F&Z, L&SP, F&SP, F&SN, F&Z,
L&SP, F&SP, F&SN, F&Z, R&SP, F&SP, F&SN, F&Z

Which means turn left, go forward, brake, turn right, go forward, brake, turn left, go forward, brake, turn left, go forward, brake, turn right, go forward, brake, stop. Thus, the process of path planning and navigation has been completed. Note that, in here we use Manhattan distance from the start grid to destination grid, which is a standard heuristic for a grid map.

Note that the priority of obstacle avoidance is higher than path planning, which means if the local grid map is showing that a static or dynamic obstacle is within the danger distance, the path planning function will be interrupted to ensure the robot will not hit something.

### 3.5.5 Simulation

This part is actually not under the main topic of this disclosure. During the COVID-19 self-quarantine period, the testing environment for the presented robot in real world is not realistic. In that case, we launched a small project about simulating the robot with whole functionalities except data fusion based on robot operating system (ROS) and Gazebo. This part will not be introduced in detail, but the simulation environment construction and algorithms used will be introduced briefly.

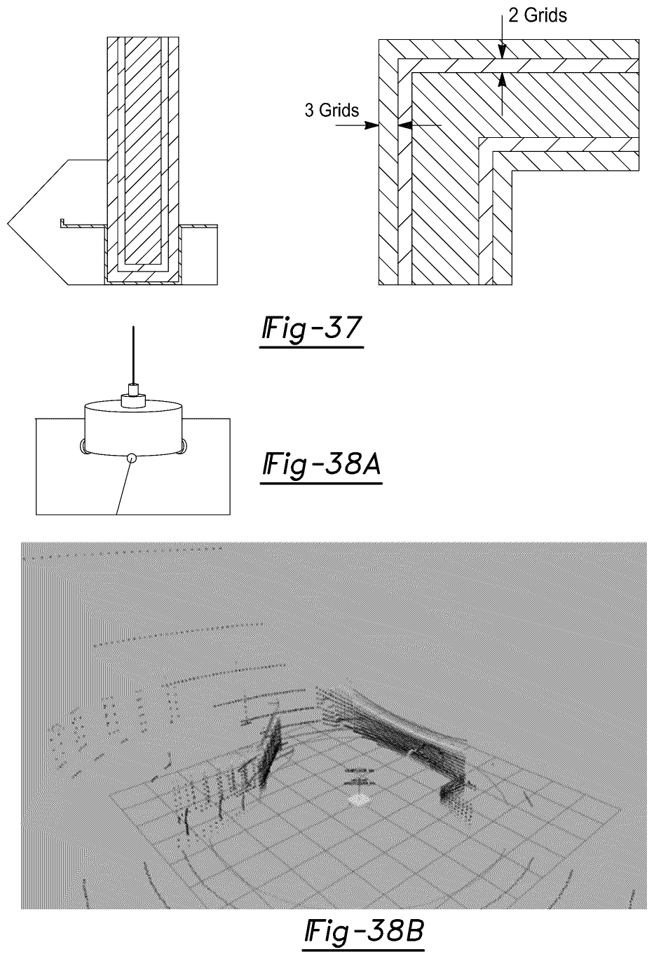

Simulation Environment: The whole simulation environment is based on ROS Kinetic and Gazebo 8.6. The robot in this simulation was built in shape of a single cylinder with two differential driving wheels and one unpowered omnidirectional wheel, which shares the same kinetic model as the robot presented in this disclosure in real world, as shown in FIG. 38. The two little black blocks at the top of the cylinder are camera and Velodyne 3D LiDAR. The speed, heading, and acceleration information about the robot dynamics can be subscribed through built-in libraries with ROS. For controlling the robot, ROS also provides the built-in libraries to publish the control command to the model of robot. It can be controlled through keyboard, or we can send commands generated by other functions such as obstacle avoidance or navigation to it.

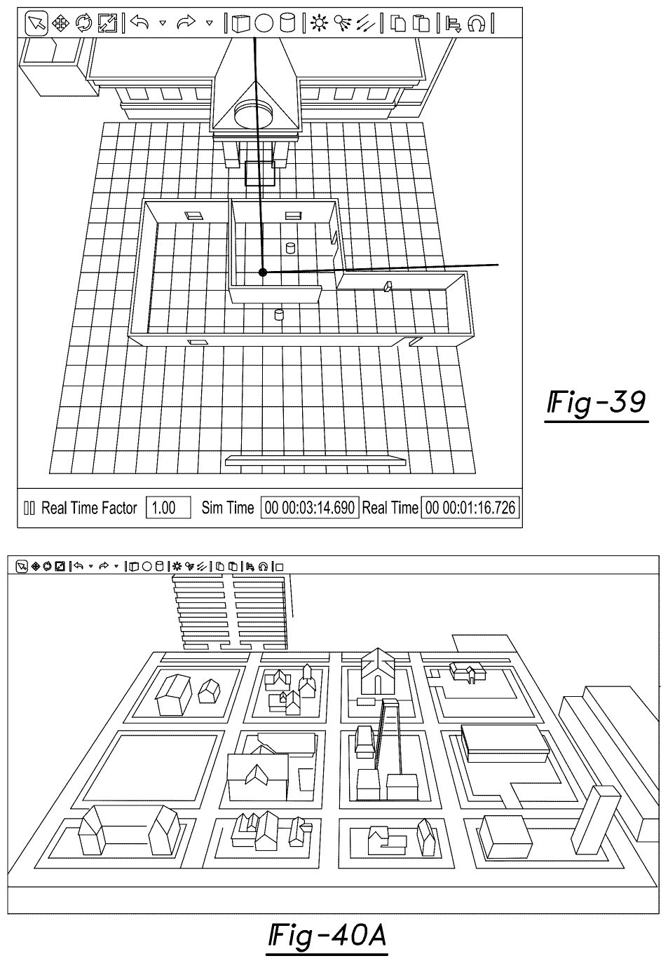

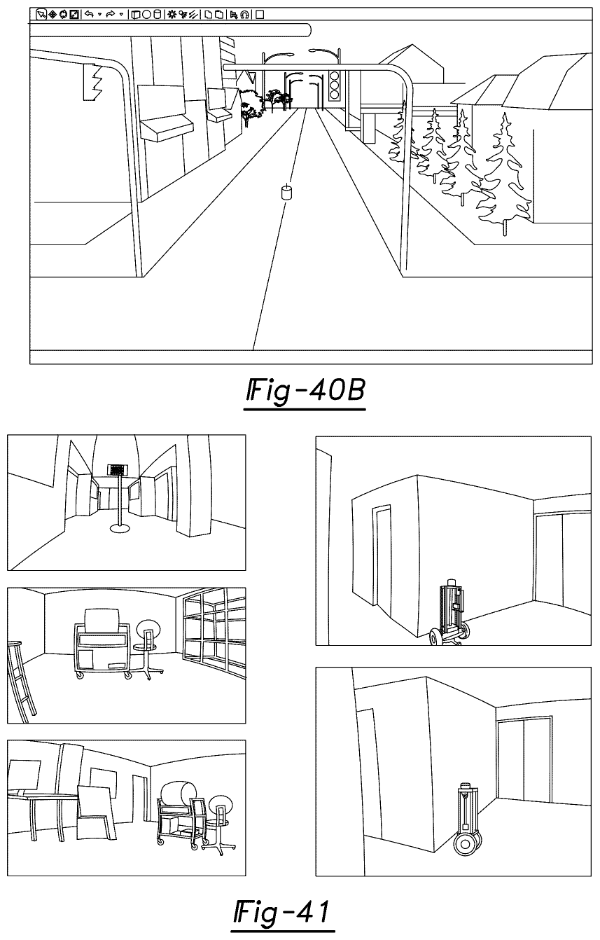

Then, with the model of robot, we arranged two simulation scenarios including both indoor and outdoor from built-in models of objects in Gazebo, as shown in FIG. 39 (indoor) and FIG. 40 (outdoor). The outdoor scenario simulates a real city with the focus on traffic, which concludes the trafficway, buildings, sidewalks, traffic signs and lights and so on. Note that it also concludes some pre-programmed dynamic objects including pedestrians and moving cars.

In this simulation, the functionalities featured in real robot including obstacle avoidance, 2D SLAM, and path planning have been implemented except data fusion. Besides, the 3D SLAM has also been implemented since the ROS provides open-source algorithm for 3D SLAM. Note that all these functions are supported by open-source, and the main work of this project is integrating them together simultaneously in the simulation robot.

Obstacle Avoidance: Differed from the robot presented in this disclosure, the obstacle avoidance in simulation is realized based on path planning. The robot will follow the path generated and circle around the obstacles.

2D SLAM: Open-source library, Gmapping.

3D SLAM: Two open-source libraries, Loam and Lego-loam.

Path Planning: Based on the map constructed by 2D SLAM, manually select destination on the map. The localization algorithm is based on AMCL.

### Section 4

### Testing and Results

The performance of this presented robot can be reflected in many aspects. Some aspects of the performance can be quantized through universal indicators such as accuracy of map or run time. However, in this disclosure some functions of the robot were just tested to present that the robot has the ability of such autonomous driving technologies, and some further advanced algorithms can be developed based on this platform. Thus, in this chapter, the test environment, procedure and results will be introduced to accord readers an overview about how we present testing on this robot, while not only just implementing those functions mentioned together but also fusing functions together and considering it as an autonomous driving platform.

### 4.1 Test Procedure and Environment

In this disclosure, there is no fixed place as test environment because the robot was built to has the operational capability under different scenarios. On the other hand, different functions of the robot may need distinct environments to test the performance individually. The basic physical environment of testing the robot can be divided into indoor and outdoor mainly including research lab, university building hallway, my personal room (the robot had been tested in my room sometimes due to the COVID-19) and campus parking lot as shown in FIG. 41. The environments will be introduced in detail together with test procedures according to different uses on below.

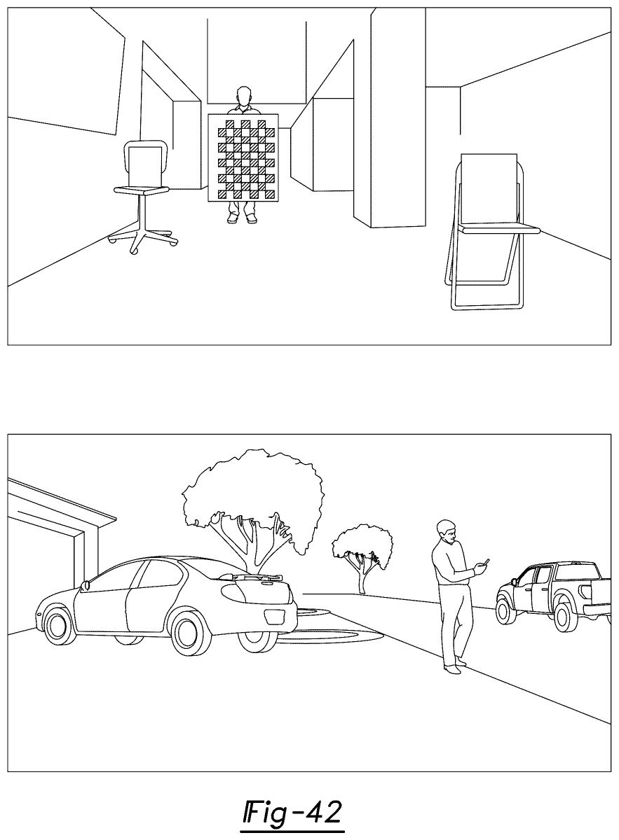

For testing data fusion: The target object can be described as shown in FIG. 42. Since the target of this function is to back-project pixels from images to point cloud data, we first set a few landmarks such as the 7×10×30 checkerboard and two rectangle planks on chairs at an indoor scenario (university's building hallway). Then we put the robot outside the apartment, use a sedan vehicle and a walking person as the target objects, as also shown in FIG. 42.

For testing obstacle avoidance: The indoor environment includes research lab, university building hallway and my room, while the outdoor environment includes the campus parking lot.

The selected obstacles in these scenarios include both static and dynamic as shown in Table 11 as well as other specification.

TABLE 11
Specification of different test environments.

| | | Obstacles | | | Special |
|---|---|---|---|---|---|
| | Scenario | Static | Dynamic | Size | Feature |
| Indoor | Research | Table, | Moving | Small, | Relatively |
| | Lab | Chair, | person | around | low-friction |
| | | Wall, | (me) | 5 × 5 m | and even |
| | | | | | ground. |
| | | | | | Narrow |
| | | | | | space, |
| | | | | | obstacles |
| | | | | | are placed |
| | | | | | randomly |
| | | | | | with different |
| | | | | | heights. |
| | University | Wall, | Moving | Medium, | With carpet |
| | Building | Pillar, | people | around | on the |
| | Hallway | Vending | | 5 × 10 m | ground |
| | | Machine | | | which |
| | | | | | results in |
| | | | | | higher |
| | | | | | friction. |
| | | | | | Relatively |
| | | | | | clear space, |
| | | | | | obstacles |
| | | | | | are placed |
| | | | | | orderly with |
| | | | | | same |
| | | | | | height. |
| | Room | Wall, | Moving | Small, | Same as |
| | | Bed, | person | around | hallway, |
| | | Table | | 5 × 3 m | carpet on |
| | | | | | the ground. |
| | | | | | Narrow |
| | | | | | space, |
| | | | | | obstacles |
| | | | | | are placed |
| | | | | | randomly |
| | | | | | with different |
| | | | | | height. |
| Outdoor | Campus | Cars, | Moving | Large, | Cement and |
| | Parking | Street | people | around | tarmac |
| | Lot | Light, | | 10 × 10 m | surface, |
| | | | | | relatively |
| | | | | | medium |
| | | | | | friction but |
| | | | | | uneven and |
| | | | | | rugged |
| | | | | | ground. |
| | | | | | Space in |
| | | | | | here is very |
| | | | | | clear except |
| | | | | | between |
| | | | | | cars, |
| | | | | | obstacles |
| | | | | | are placed |
| | | | | | orderly with |
| | | | | | same |
| | | | | | height. |

For SLAM and path planning: Since the prerequisites of planning path is constructing a map for environment, we test these two functions simultaneously in the same scenario mostly. Also, for testing the autonomous driving ability of the robot, the test environments for these two functions are the same as for obstacle avoidance except research lab because we could not present testing in there due to COVID-19. Note that the complexity of the environment can affect the accuracy of mapping, so that we sort the complexity of these scenarios according to the number and placing of obstacles, as shown as followed:
Campus parking lot>Room>University Building Corridor

Due to COVID-19, the main testing scenario for SLAM and path planning is my personal room. It has a medium complexity and size of 5×3 with obstacles including wall, bed, table, chair, boxes and moving person. The space in this environment is relatively not clear with a narrow corridor on the side. For this scenario, the performance of SLAM and path planning can be shown mainly as mapping accuracy and run time speed, which will be presented later in Section 4.2.3 and 4.2.4.

### 4.2 Test Results

### 4.2.1 Obstacle Avoidance

There is not a specific indicator presenting the performance of obstacle avoidance. However, the general performance of this function can be embodied through testing at these mentioned scenarios. The best way to present the performance of obstacle avoidance will be using a demo video. But in here, we will present the result of constructed 2D local grid map, which is the guidance and foundation for obstacle avoidance.

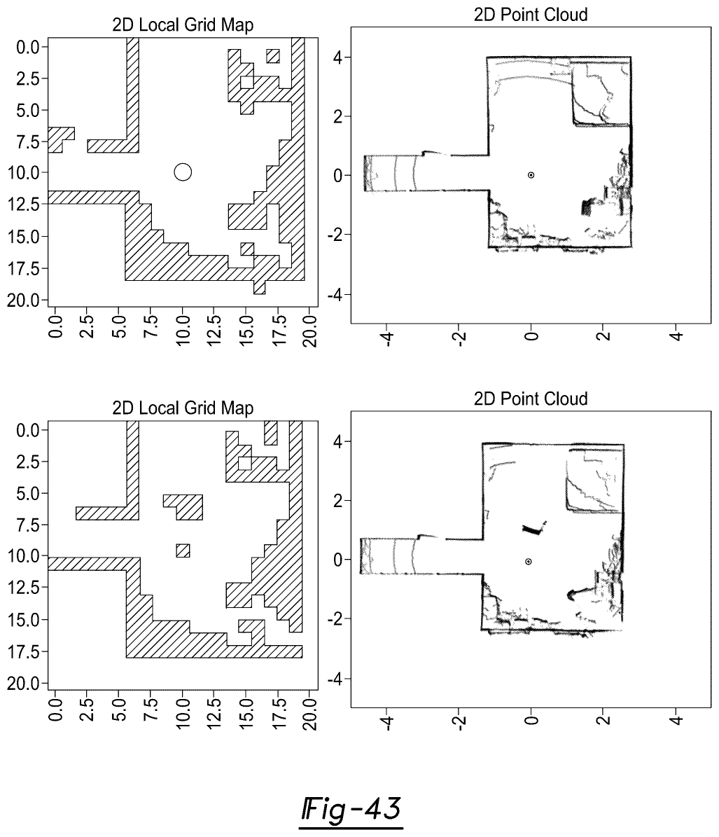

As one of the mentioned scenarios, the raw 2D point cloud of my room has been shown in the right side of FIG. 43 below. By comparing the 2D point cloud and real picture of my room, it is obvious that the basic geometrical information has been reflected and restored in detail. For example, the door left open ajar on the side of the corridor can be identified from the 2D point cloud easily. The geometric specification of map has been shown in Table 12, which is the same as the size and refresh frequency mentioned in Section 3.

TABLE 12
Specification of 2D local grid map.

| | |
|---|---|
| Grid Size | 0.3 m |
| Map Size | 3 × 3 m or |
| | 21 × 21 grids |
| Map Refresh | More than 5 Hz |
| Frequency | |

However, some outlies have also been collected since the 16 channel LIDAR has a vertical scan range in +15° as mentioned before. For example, the cambered curve appeared at the end of the corridor and near the bed is caller ground hit, which is the points reflected by the ground when the laser beam #0 and #1 hit the ground. The appearance of such outlies does not means that area is occupied by any obstacles. Hence, with the data pre-processing methods mentioned in previous chapter, we eliminate these outlies and set a confidence threshold to simplify the point cloud when transform it to grid map.

As the result, the 2D local grid map has been shown in FIG. 43 next to point cloud. It is clear that the necessary details of real world have been mostly restored and expressed on the map such as the door left open ajar, while the outlies have been deleted and the whole map performs much more clear than raw data. A map such as this one can be passed for extracting the fuzzy language of {Left Distance, Front Distance, Right Distance}, and it can be used to guide the robot for avoiding obstacles and exploring the environment. At this scenario, the robot close area of all left, right, and front is clear, so that the robot is free to move around but according to the fuzzy control rule base, the robot should go forward.

If there is another obstacle moving across or around the robot, which is also known as a dynamic obstacle, we ensure the safety of the robot by maintaining an adequate refresh frequency. The refresh frequency of obstacle avoidance depends on and less than the scan frequency of LiDAR, which is 10 Hz. Through practical testing, the 2D grid map will update less than 0.3 sec. Considering the lag from sending command to reaction of servos, and the inertia of robot motion, the refresh frequency satisfied the safety concern.

### 4.2.2 Data Fusion

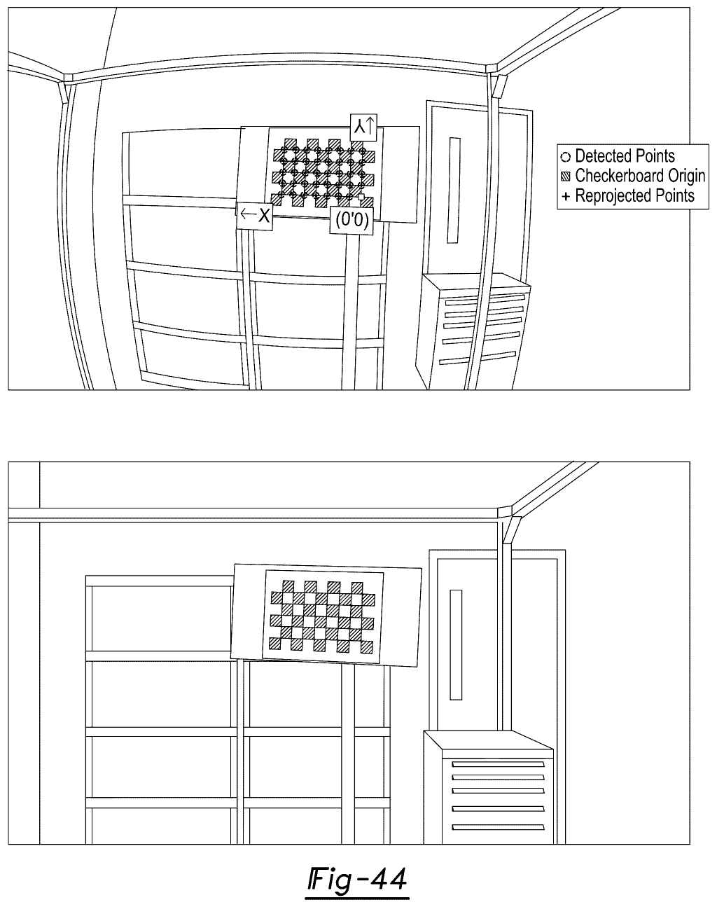

First the calibration of camera result will be presented as shown in FIG. 44. The detected points, checkerboard origin, and reprojected points have been marked in FIG. 44 above, while the image below has shown the result of undistorted image.

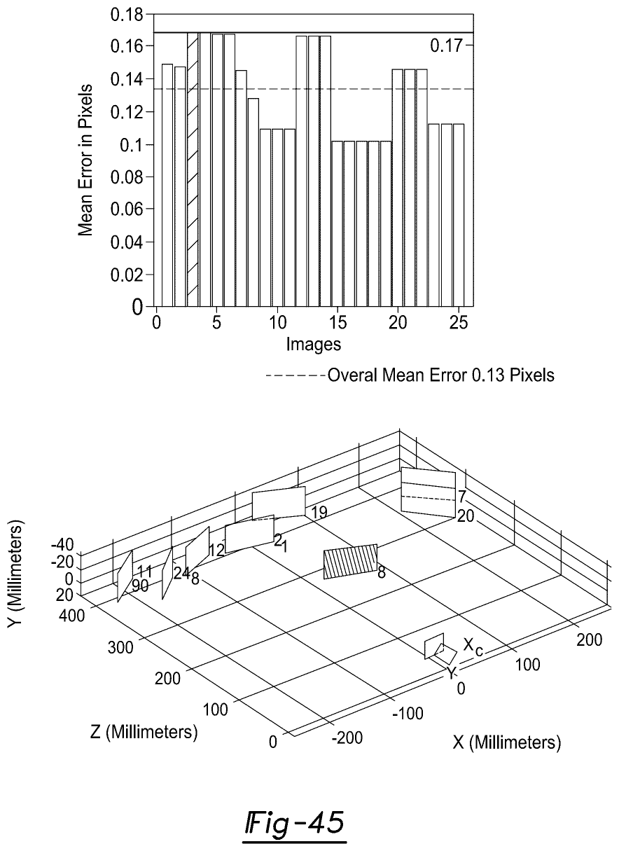

Then with a set of 25 images, we are able to calculate the reprojection error of camera calibration session. The result has been shown in FIG. 45, and the overall mean error is 0.13 pixels, which is acceptable. The 3D representation of checkerboard in different position at a camera-centric order has also been shown in FIG. 45.

Also, some other numerical results including the intrinsic matrix has been shown as below:

Intrinsic matrix:

$$[ \begin{matrix}1210.70 & 0 & 0 \\ 0 & 1211.87 & 0 \\ 969.62 & 541.14 & 1\end{matrix} ]$$

Principal Point: [969.62 541.14]
Radial Distortion: [−0.3644 0.1177]
Mean Reprojection Error: 0.1338

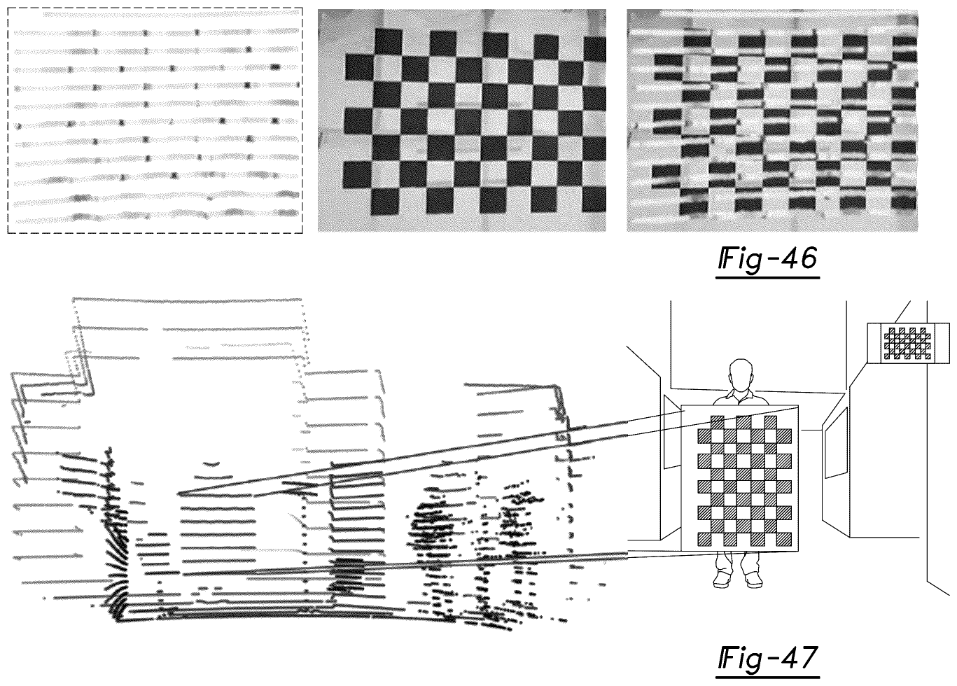

After these, the result of detecting checkerboard corners has been shown in FIG. 46. The different color on point cloud means different reflection intensity.

For the larger checkerboard, find the four corners of the whole checkerboard as the reference points, and match those points corresponding to undistorted image can also calculate the extrinsic parameters, as shown in FIG. 47.

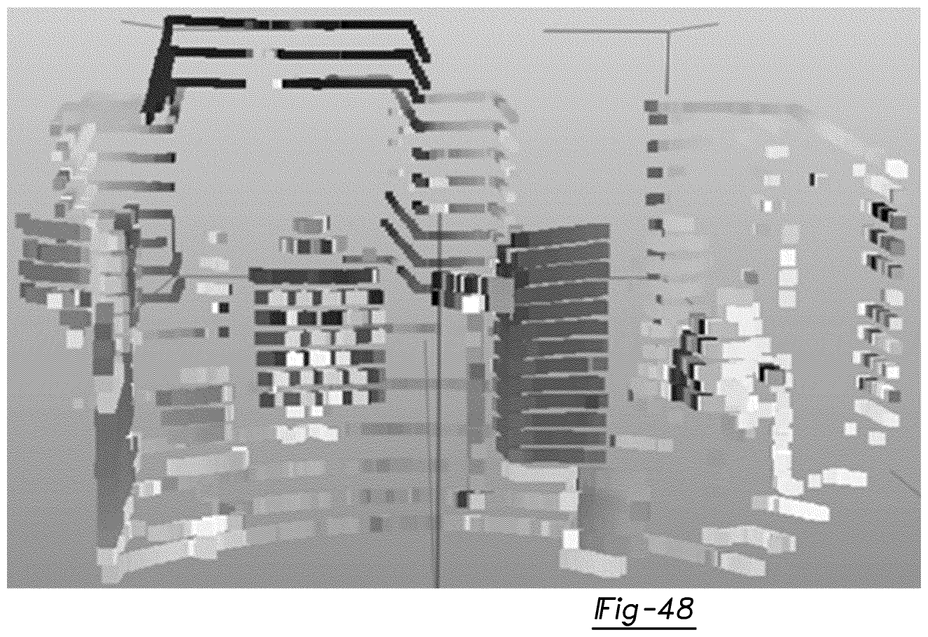

Finally, the pixels of image can be back projected to point cloud as shown in FIG. 48.

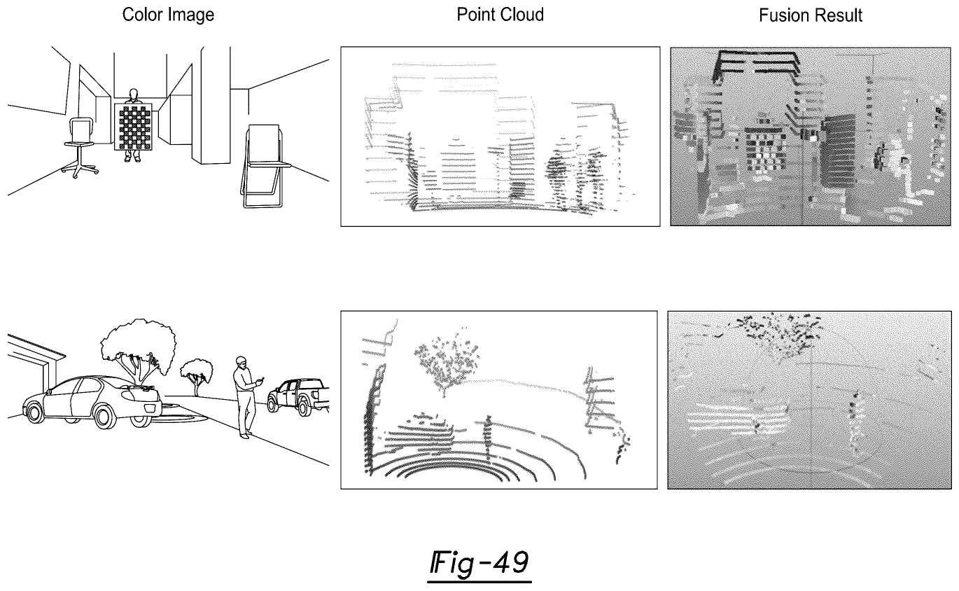

With the intrinsic and extrinsic parameters, some other data captured by this robot can also be fused since the relative spatial position relationship between LIDAR and camera remains the same. Here we illustrate this by presenting another example in outdoor scenario. The undistorted image captured from camera has been shown in FIG. 49. while the 3D point cloud captured from LiDAR in the same scene has been shown in FIG. 49. The result of fusing the 3D point cloud and 2D image together can be presented as following:

### 4.2.3 2D SLAM

The 2D SLAM includes two main targets, localization and mapping. In here, since we are using the dataset capture by our own, we did not use a fixed ground truth to verify the accuracy of the map constructed. Besides, we only have performed this function on a single scenario, which is my room.

TABLE 13
Measurements of objects in map and reality.

| | Map Measurement | | Reality |
|---|---|---|---|
| Object | In grids | In cm | Measurement |
| Bed (Queen | 42 grids | 210 cm | 205 cm |
| Size) | | | |
| Wall | 51 grids | 255 cm | 247 cm |

However, the accuracy of map constructed can be defined as accurate since the size of some of the landmarks from the map generated can match the corresponding objects in actual world. In here we chose the bed and wall as the landmark, and we measure the length of objects both in map and reality as shown in Table 13.

Here are also some results showing both the trajectory and the map. The meaning of different color represents:
Grey: Unexplored zone
Green: Current LiDAR hit
Black: Obstacles or occupied
White: Free zone
Blue: Trajectory

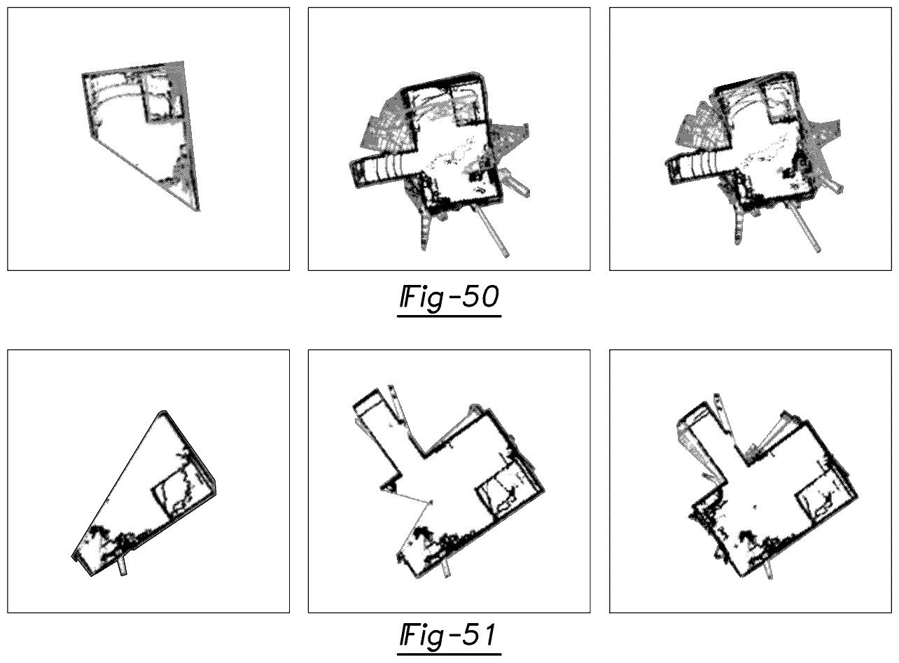

To illustrate the process of map construction, we shielded half of the scan range of LiDAR from 360° to 180°, and then we let the robot move and explore randomly in the environment, as shown in FIG. 50. The blue grids have recorded the trajectory of the robot when moving. Also, we let the robot stay in place and turn it around in the same environment, and the map as shown in FIG. 51.

Obviously, the map generated when the robot is stationary has higher quality then moving. The possible reason can be various, but the most influential one is that the LiDAR may capture some outliers when the robot is moving because the vibration caused by the even ground. Although we have already applied filter and threshold for matching different frames capture by LiDAR, some outliers still appeared. Actually, this is a common phenomenon when mapping through a LiDAR both in 2D and 3D. We improve something is that we removed the ground hit, and we integrate this function together with other functions simultaneously.

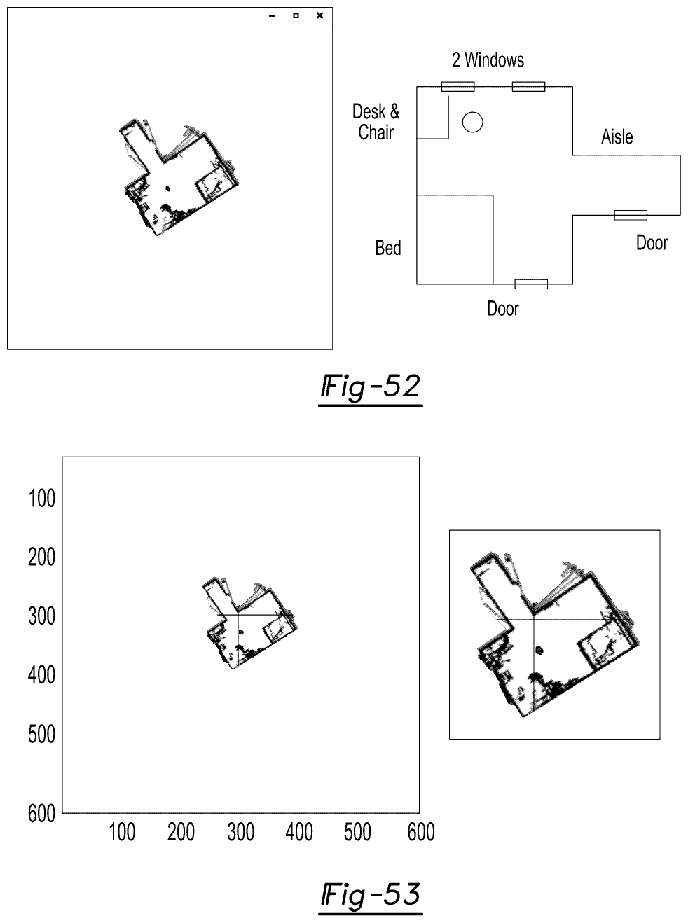

At last, the real scale (30×30 m) of the map and corresponding topographic diagram has been shown in FIG. 52

### 4.2.4 Path Planning

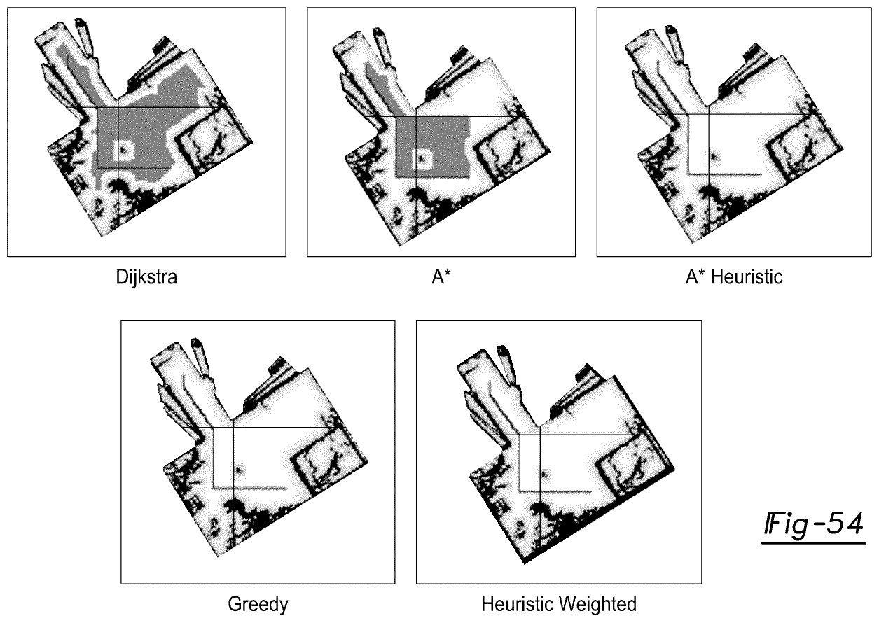

As mentioned before, the input of path planning is the grid map constructed from SLAM. Firstly, the map for path planning converted from SLAM has been shown in FIG. 53. The map for path planning still share the same scale with the original map, which is 600×600 grids, but the difference is that we set the save zone (light blue color) and dangerous zone (pink color) alongside the obstacles.

Then, after setting the start (default is the current location of robot) and destination and selecting the method, the path will be generated as shown in FIG. 54. The red color means the area that has been traversed through the planning process. It is clear that the path generated through different method presents the same, which means that under a simple scenario with not too much obstacle to circle around, the results planned by best-first search will not show too much difference.

TABLE 14
Path scoring time for different algorithms.

| | Path Scoring |
|---|---|
| Method | Time |
| Dijkstra | 1.114 s |
| A* | 0.692 s |
| A* Heuristic | 0.094 s |
| Greedy | 0.044 s |
| Heuristic | 0.043 s |
| Weighted | |

Also, the time consumed through scoring the path under different methods has been shown in Table 14 above. Though the path generated presents the same, the time efficiency of different methods illustrates significant difference. The Dijkstra algorithm consumed the longest time, while Greedy and heuristic weighted algorithm planned the path at almost the rapidest speed.

### 4.2.5 Simulation Results

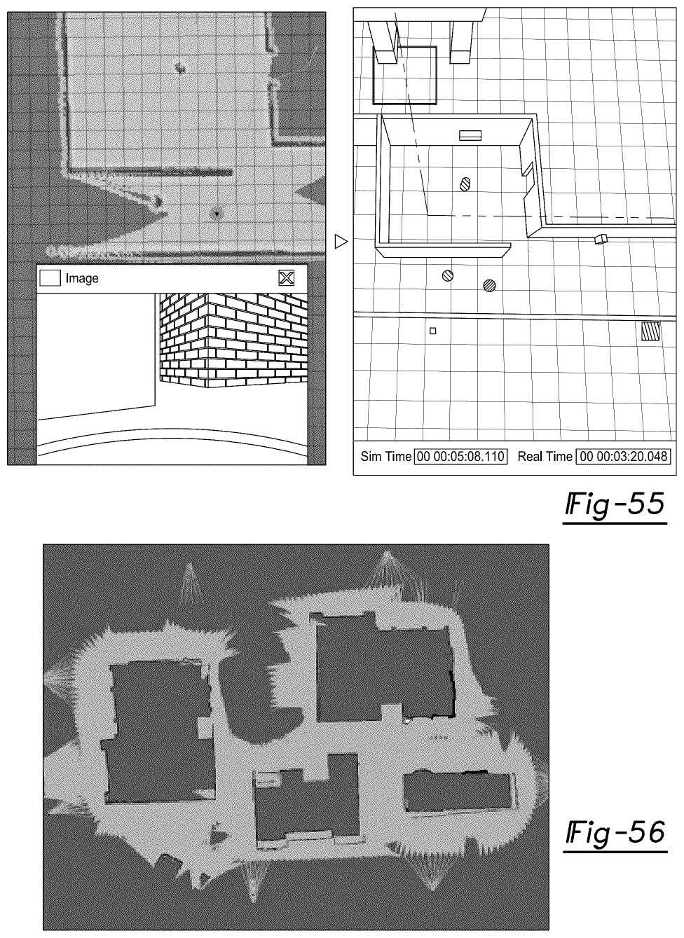

Here are some results of the simulation. The first one is the 2D map constructed in indoor scenario and path planning. The right side in FIG. 55 is the model of both the building and the robot (blue one is the robot), while left side is the 2D map constructed and video visualization streamed from camera. The orange spot is the current position of robot, and the green curve is the path planned to the preset destination.

Then the 2D SLAM result constructed at outdoor scenario has been shown in FIG. 56. The black outline is the outer shape of several buildings.

The process of 3D SLAM has been shown in FIG. 57. The robot has been circled in red color on the right side, and the corresponding position of the robot has also been shown on the left side.

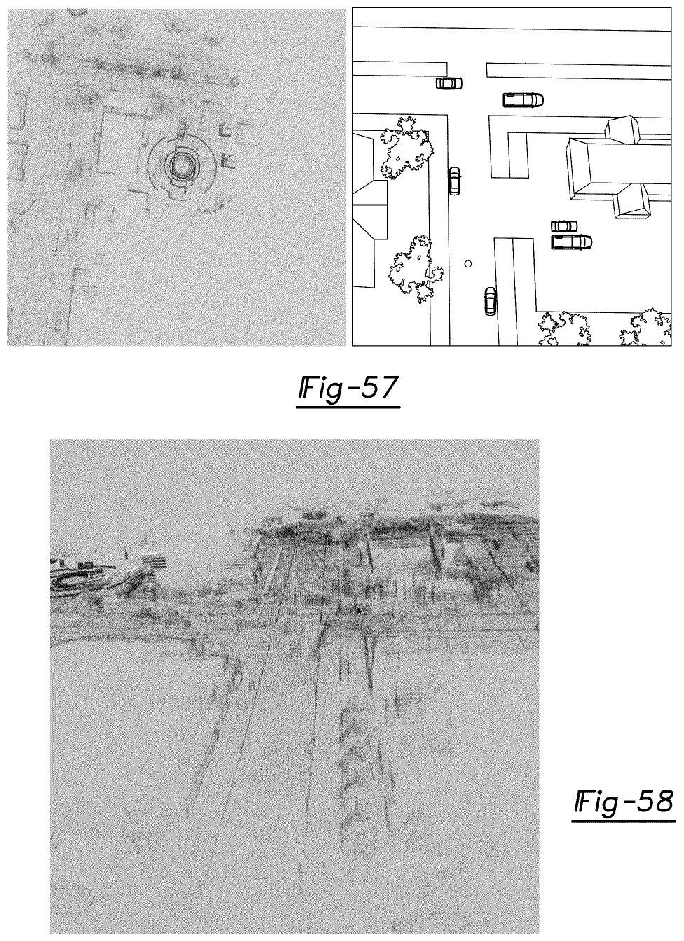

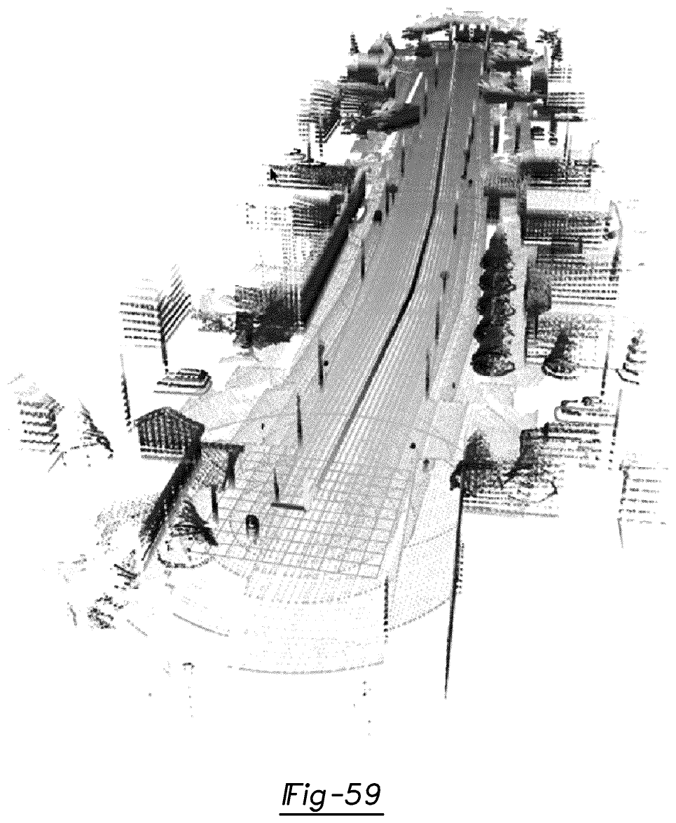

At last, the results of 3D SLAM have been shown in FIG. 58 and FIG. 59. It is obvious that the 3D map constructed by Loam algorithm has higher density in point cloud than Lego-loam algorithm. But each map has excellent quality.

### Section 5

### Conclusion and Scope

In this disclosure, an autonomous driving robot was presented and built based on a SEGWAY self-balancing scooter. The robot was designed under the principle of modern intelligent and autonomous robotics, which consists of three main body frames including perception, decision-making, and action. This disclosure described the hardware/software structure, methodologies for different functions, and testing environment and results. The hardware system of the robot includes sensors, actuators, and processors. Several sensors including a 3D LiDAR, a monocular network camera, an IMU, and two-wheel encoders were implemented, which completed the task of perceptual collection and provide data to software system. Two digital servos connected with a pendulum and steer rod formed the actuators, which realized the control over the robot physically. Two Arduino Uno microcontrollers and a Microsoft Surface fulfilled the data processing and communication ability. The software system of the robot realized the assignments including collecting data from the sensors and transporting to higher levels, processing data, several functionalities fulfillment, and send command back to actuators to control the robot. We presented several functionalities developed under Python 3.6 including obstacle avoidance based on 2D local grid map and fuzzy logic, data fusion based on co-calibration, 2D SLAM based on Rao-Blackwellized particle filter, and path planning based on 2D global grid map. In this disclosure, the test procedure and environment has been introduced, and we performed the testing of the robot under several scenarios. The test results illustrated that all the functions had achieved the excepted effect.

Overall, the robot has the functional ability of presented autonomous functions, which can be considered as an autonomous driving robot for some simple tasks. Besides, the modular hardware and software structure of this robot has been proven that it can be considered as a platform for developing further advanced autonomous driving or general algorithms.

### 5.1 Limitations

Although the robot presented in this disclosure has fulfilled all the functions, it still has some limitations in some respects. For example, we have not performed testing about 2D SLAM in an outdoor scenario, and the method chose for 2D SLAM is not suitable for big scale and open scenarios. Also, the path planning function can be added in a closed-loop control for retrieving the position of robot when following the path to destination.

Besides, the accuracy about some of the results was measured roughly due to the limitation of testing environment. Compared with other autonomous robots, the functionality of our robot is complete, which can be illustrated through Section 4 and demo videos. But the robot lacks consistent indicators to verify the performance. Hopefully, in the future the robot can be tested in a standardized field or scenario in order to verify the performance.

5.2 Real World vs. Simulation

The other thing worth mentioning is that the comparison between the real world and simulation. From a macro perspective, the whole software frame of the robot in real world was developed under Python 3.6, while the robot in simulation was developed under ROS (C++). Generally, the running speed of ROS was considered as higher than Python, which means the robot in simulation should has better performance in real-time, because the main language used of ROS is C++. However, the test results about map refreshing frequency illustrated that the algorithms developed under python has a running speed comparable to that of ROS. Although we did not make a detailed comparison under strict control of variables, it might be expected that developing some autonomous driving algorithms, especially focusing on mapping, localization, and movement control, can be realized through Python.

Besides, the robot in simulation has more functions (such as 3D SLAM) than in real world, and the performance of 2D SLAM and navigation functions in simulation presents better as well. The reason is that as a well-known open source developing environment with high maturity especially in robotics, ROS has integrated many developers and algorithms with better performance.

### 5.3 Scope

As mentioned before, the robot presented in this disclosure can provide a platform for developing autonomous driving algorithms. Moreover, another feature of the design of the present robot is modularization. The hardware and software system are all modular, which means the robot can be added or removed with certain functions without affecting other functions. This can be convenient in that some hardware can be replaced by other hardware with lower cost, or some more advanced algorithms (e.g., 3D SLAM) can be developed based on this robot since it has the perception both for environment and itself, which meets the basic requirements in autonomous driving area.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A two-wheeled, self-balancing robot comprising:
a pair of drive wheels;
a support structure operably coupled with the pair of drive wheels;
a self-balancing and drive system operably coupled with the support structure and the pair of drive wheels to output a drive power to the pair of drive wheels to maintain balance of the support structure in response to data;
at least one sensor collecting and outputting the data to the self-balancing and drive system;
at least one actuator operably coupled to the self-balancing and drive system; and
at least one processor configured to output a control signal to the self-balancing and drive system.

2. The two-wheeled, self-balancing robot according to claim 1 wherein the at least one sensor comprises a LIDAR system coupled to the support structure and outputting data to the self-balancing and drive system.

3. The two-wheeled, self-balancing robot according to claim 1 wherein the at least one sensor comprises a monocular network camera coupled to the support structure and outputting data to the self-balancing and drive system.

4. The two-wheeled, self-balancing robot according to claim 1 wherein the at least one sensor comprises an inertial measurement unit coupled to the support structure and outputting data to the self-balancing and drive system.

5. The two-wheeled, self-balancing robot according to claim 1 wherein the at least one sensor comprises two-wheel encoders coupled to the support structure and outputting data to the self-balancing and drive system.

6. The two-wheeled, self-balancing robot according to claim 1 wherein the at least one actuator comprises two digital servos connected with a pendulum and steer rod.

7. The two-wheeled, self-balancing robot according to claim 1 wherein the at least one processor comprises at least one microcontroller and a central processing unit.

8. The two-wheeled, self-balancing robot according to claim 1 wherein at least one of the at least one processor and the self-balancing and drive system is configured to provide the drive power to the pair of drive wheels to provide obstacle avoidance control.

9. The two-wheeled, self-balancing robot according to claim 8 wherein the obstacle avoidance control is provided based on 2D local grid map and fuzzy logic.

10. The two-wheeled, self-balancing robot according to claim 8 wherein the obstacle avoidance control is provided based on data fusion based on co-calibration.

11. The two-wheeled, self-balancing robot according to claim 8 wherein the obstacle avoidance control is provided based on 2D SLAM based on Rao-Blackwellized particle filter.

12. The two-wheeled, self-balancing robot according to claim 8 wherein the obstacle avoidance control is provided based on path planning using on 2D global grid map.
